(19) United States
(12) Patent Application Publication
(10) Pub. No.: US 2018/0157255 A1
(43) Pub. Date: Jun. 7, 2018

(54) SYSTEMS AND METHODS OF UNMANNED VEHICLE CONTROL AND MONITORING

(71) Applicant: Precision Autonomy Pty Ltd, Kensington (AU)

(72) Inventors: Mark HALVERSON, Kensington (AU); Cliff SEETO, Kensington (AU); Jeremy SOH, Kensington (AU)

(21) Appl. No.: 15/573,405

(22) PCT Filed: May 12, 2016
(86) PCT No.: PCT/AU2016/000163

§ 371 Date: Nov. 10, 2017

Related U.S. Application Data
(60) Provisional application No. 62/161,981, filed on May 15, 2015.

(30) Foreign Application Priority Data
May 12, 2015 (AU) 2015901727

(51) Int. Cl. G05D 1/00; G07C 5/00; G07C 5/08; G08G 9/02

(52) U.S. Cl. CPC G05D 1/0055; G07C 5/008; G08G 9/02; G07C 5/0808; G07C 5/0841; G07C 5/0816

(57) ABSTRACT

A computer implemented method of real-time condition monitoring of UMVs, the method including the steps of: receiving, in a control centre computer processing system, unmanned vehicle (UMV) condition data from a UMV; receiving, in the control centre computer processing system, UMV condition data from a network of condition-sensing UMV tracking stations: comparing, in the control centre computer processing system, the condition data from the UMV and the condition-sensing UMV tracking stations; and instructing, by the control centre computer processing system, the UMV to take an action in response to the comparison of condition data.

### TECHNICAL FIELD

The present invention relates generally to monitoring and control of unmanned vehicles (UMVs).

### DEFINITIONS

Throughout this specification and the claims that follow, the term unmanned (UMV) is to include, without limitation: autonomous and remotely-piloted vehicles such as for example nano and swarming unmanned aerial vehicles (UAVs) including for example quadcopters of approximately 100 mm×100 mm, small to mid-size UAVs (quadcopters of up to about 2 m×2 m), larger UAVs including for example aeroplanes, drones, hexacopters and octacopters of wingspan in the tens of metres, land surface autonomous vehicles such as for example precision agriculture land based vehicles working in tandem with UAV swarms, or marine surface UMVs with missions such as delivering goods or search and rescue, as well as marine sub-surface UMV for similar usage. The definition would also apply to multi-modal vehicles which could be capable of transport on which would span aerial, marine surface, sub-marine and land. And also in smaller spaces like a home where there is growing demand for autonomous capability example such as home care robots would also be included in the UMV definition.

Throughout this specification and the claims that follow, there is discussion of “position sensing” and “condition sensing” as it relates to a UMV. It is to be understood that “condition” is to cover a range of characteristics, including without limitation, temperature of a component of the UMV, overall speed of the UMV, battery charge, current draw of any one of any particular component on board such as for example motors, lights, other servo motors, angular speed of a component of the UMV, altitude of the UMV, attitude of the UMV, latitudinal and longitudinal position of the UMV, heat load, and rate of change of any one of these characteristics, the latter of which is in some cases, processed, but in others, directly sensed.

There are portions of this document which describe Aerial specific implementations of the system, but the bulk is applicable across all aforementioned types of Unmanned Vehicles. And while many of the examples given throughout the document reference a subset of UMVs, specifically Unmanned Aerial Vehicles (UAVs) the application of the systems spans ail classes of UMVs as defined above.

Any reference to or discussion of any document, act or item of knowledge in this specification is included solely for the purpose of providing a context for the present invention. it is not suggested or represented that any of these matters or any combination thereof formed at the priority date part of the common general knowledge, or was known to be relevant to an attempt to solve any problem with which this specification is concerned.

### BACKGROUND

Unmanned vehicles and particularly Unmanned Aerial Vehicles are becoming widespread but to date their control and monitoring systems are generally limited to manual control via a wireless device, even with a virtual reality headset. Both manual and autonomous control, where available, lack features, accountability, flexibility and safety, making UMV control and management difficult in the context of a constantly-changing urban landscape, other UAV traffic, and other issues confronting commercial missions; in densely populated areas. This applies equally to land and marine applications which are difficult, dangerous, expensive, or impossible with manned vehicles. These issues compound the dangers posed by typical factors such as weather faced by aircraft and surface vehicles. In addition, there is no usage framework which helps manage these devices and their missions in the context of traditional systems. The inventors believe this foundation is required to support an entire category of industries enabled by unmanned vehicles.

GPS systems are unreliable and inaccurate in a dense urban environment and unmanned vehicles either are land bound or are restricted to flying at 400 ft AMSL. This means that obstacles such as buildings and other UMVs must be accurately navigated around rather than flown over. In those circumstances the known positioning systems lack accuracy.

The present inventors have developed new methods and systems of unmanned vehicle control and monitoring, Some embodiments broadly seek to safely and substantially seamlessly integrate unmanned vehicles with traditional infrastructure, transportation, logistics, civil, and first responder usage and systems, and throughout this specification these current common uses will be referred to as Traditional Systems.

### SUMMARY

Broadly, the present technology manages issues related to short-term unmanned vehicle (UMV) operations and long-term UMV lifespan events. Thus, the present technology individually and collectively manages short and long term UMV lifespan events including licensing, manufacturing, airworthiness, maintenance, flight operations, and compliance and safety. This is done generally for the safe integration of unmanned systems into Traditional Systems.

One aspect of the present technology broadly facilitates autonomous control and monitoring of unmanned aerial vehicles (UAV) by comparing mission path data obtained by one or more UMV position tracking stations with position data obtained directly from UMVs in mission.

Broadly, other aspects of the present technology also provide a method and system of autonomously facilitating the location of an unmanned vehicle in the event of an onboard communications failure or an identified inappropriate change in navigation or control from an unauthorized operator or program.

Broadly, the present technology further provides a method and system of autonomously and securely controlling an unmanned vehicle in the event of an onboard communications failure or unauthorized hijacking of control.

Broadly, still other aspects of the present technology provide a method and system of autonomously and securely controlling an unmanned vehicle in the event of non compliance with a submitted mission plan.

Broadly, further aspects of the present technology provide a method and system of autonomously avoiding collisions of unmanned vehicles with other like unmanned vehicles and other objects.

In accordance with an aspect of the present technology there is provided a computer implemented method of monitoring or controlling an unmanned vehicle (UMV) through its off-mission lifecycle and planning as well as in-mission actions, the method including the steps of:
interrogating a UMV for identification data;
comparing the UMV identification data with data associated with that UMV taken from the group consisting of: registration, licensing, certification, manufacturing and airworthiness, flight operations and communications, mission and emergency plans, maintenance, compliance and safety;
taking a relevant action in response to the data comparison.

In one embodiment the relevant action is taken from the group consisting of: charging an owner of the UMV a registration and/or license fee or a fine; grounding the UMV before some compliance action is taken; instructing maintenance before mission; request further mission plan information before mission; request user or owner training before mission; instructing UMV guidance systems or UAV-specific avionics take compliant action; permit restricted flight or mission; and permit the flight/mission along flight/mission plan.

In accordance with one other aspect of the present technology there is provided a computer implemented method of real-time monitoring of UMVs, the method including the steps of:
receiving, in a control centre computer processing system, UMV condition data from the UMV directly;
receiving, in the control centre computer processing system, UMV condition data; from a network of condition-sensing stations;
comparing the condition data from the UMV and the condition-sensing stations to obtain one or more mission or emergency action paths for the UMV.

In accordance with still another aspect of the present technology there is provided a computer implemented method of real-time condition monitoring of UMVs, the method including the steps of:
receiving, in a control centre computer processing system, unmanned vehicle (UMV) condition data from a UMV;
receiving, in the control centre computer processing system, UMV condition data from a network of condition-sensing UMV tracking stations;
comparing, in the control centre computer processing system, the condition data from the UMV and the condition-sensing UMV tracking stations; and
instructing, by the control centre computer processing system, the UMV to take an action in response to the comparison of condition data.

In one embodiment the method includes the step of recording a discrepancy, above a selected threshold, between the compared condition data obtained from the UMV and the condition-sensing tracking stations, as a fault.

In one embodiment the method includes the step of transmitting the fault to a compliance engine.

In one embodiment there is provided by the method, the step of assessing, in the compliance engine, the severity of the fault against another threshold and transmits an alarm signal if the severity exceeds the other selected threshold.

In one embodiment the alarm is forwarded to a device of an owner or pilotioperator of the UMV.

In one embodiment the alert is forwarded to law or other enforcement agencies via a telephonic signal or wirelessly transmitted to a device, together with condition data relating to the UMV.

In one embodiment the method includes the step of transferring, or receiving, into the control centre computer processing system, a mission plan, or an emergency route plan for the UMV.

In one embodiment the method further includes the steps of, by the condition sensing UMV tracking stations, interrogating a UMV to receive the mission plan therein,

In one embodiment the method includes the steps of receiving the UMV mission plan, or emergency route plan, from the UMV or the condition sensing UMV tracking stations, and storing the mission plan, or emergency route plan, in a storage device in the control centre computer processing system.

In one embodiment the method includes the step of, by the control centre computer processing system, controlling the UMV to a safe area in the received emergency plan or back to the mission path in the received mission plan.

In one embodiment the UMV is controlled in response to a fault or a plurality of faults.

In one embodiment the control path is recorded onboard the UMV or the condition sensing stations.

In one embodiment the method further includes the steps of:

receiving and recording in the control centre computer processing system, the condition of the UMV in range of each condition sensing station;

constructing in the control centre computer processing system, an executed mission route;

comparing in the control centre computer processing system, the executed mission route with the mission plan; and

recording discrepancies in a substantially permanent memory on board the UMV or in the control centre computer processing system.

In one embodiment the method further includes the step of retrieving data from a plurality of sensing systems onboard the UMV or the one or more condition sensing stations, the sensing systems selected from the group consisting of: rangefinders, laser positioning, radar positioning, optical positioning, infra-red positioning, infra-red position sensing, GSM and GPS low-orbit satellite position sensing; and

comparing the position data between the sensors.

In one embodiment the method further includes the step of comparing the positicn of two or more proximal UMVs relative to a threshold distance between them, and

sending an alarm signal to an owner device in the event that the threshold is breached.

In one embodiment the method further includes the step of disabling the UMV if the number or severity of discrepancies in the compared data are above a selected threshold.

In one embodiment the disabling step is undertaken during or after a mission, depending on the severity of the discrepancy.

In one embodiment the method further includes the step of receiving in the control centre computer processing system, position data from sensors including cameras, lasers, infra-red, thermocouple, tachometer, radar, or rangefinders, mounted on the condition sensors or on the UMV,
processing, with the control centre computer processing system, the data to predict a failure of componentry or mission route and
instruct an action be taken in response.

In one embodiment the method includes the step of, in the control system computer processing system, monitoring data transfer speed and volume between the UMV and the condition sensing stations; and
assessing if the data transfer speed is below a selected threshold;
filtering or compressing or reducing the data from selected sensors to facilitate comparison of condition data between UMV and condition sensing stations.

In one embodiment the control processing system disables the UMV unless an emergency mission route is stored on board for deployment in the event of a break in communication between the condition sensing stations and the UMV.

In one embodiment the method includes the steps of recording a discrepancy between the mission paths obtained from the data as a fault.

In one embodiment the method includes the steps of transmitting the fault to a compliance engine.

In one embodiment the method includes the step of assessing, in the compliance engine, the severity of the fault against a threshold and sounds an alarm if the severity exceeds a selected threshold. In one embodiment a warning is forwarded to an owner or pilot/operator of the UMV. In one embodiment an alert is forwarded to law or other enforcement agencies, together with condition data relating to the UMV.

In one embodiment the method includes the step of inputting or receiving into a control centre computer processing system, a UMV mission and emergency plans. In one embodiment the method includes the step of interrogating a UMV to receive the mission plan. In one embodiment the method includes the step of storing the mission plan in a storage device in a storage device in the control centre computer processing system.

In one embodiment the method includes the step of guiding the UMV to a safe area or back to the mission path in the received mission/emergency plan. In one embodiment the UMV is guided in response to a fault or a plurality of faults. In one embodiment the guiding path is recorded.

In one embodiment the method includes the step of assigning a severity rating to a fault so that the guiding step is taken when the control centre computer processing system records a fault above a threshold severity.

In one aspect, the present technology provides a method of monitoring and/or controlling a UMV, the method including the steps of
identifying objects with a combination of one or more sensing systems selected from the group consisting of a visual sensing system; a rangefinding system; a radar or electromagnetic system; a GPS system; a GNSS system;
comparing the data from the systems in a computer processing system;
making in the computer processing system a navigation decision

In one aspect, the present technology provides a computer-implemented method of monitoring a UMV, the method including the steps of:
interrogating, by a computer processing system in a condition-sensing station, one or more UMVs in real time to receive mission data from the UMV;
recording the UMV mission data in the conditioning-sensing station computer processing system;
processing the UMV flight data in the condition-sensing station computer processing system to obtain a UMV mission path.

In one embodiment the condition-sensing station transmits the UMV mission data, or processed UMV mission data to a UMV control centre computer processing system for further processing.

In one embodiment the UMV mission data is sorted by selected condition-sensing station and by timestamps.

In another aspect of the present technology, there is provided a computer-readable storage medium containing instructions to implement a method of controlling a UMV, the method including the steps of;
requesting mission path or identification data from a UMV;
obtaining condition data from the UMV and/or a condition sensing station;
comparing condition data with mission path data associated with the UMV to obtain condition deviation from mission path; and
instructing the UMV to take compliant navigation action to return to the mission path based on the results of the comparison step.

In one embodiment the method includes the step of loading mission path data into a UMV.

In one embodiment the method includes the step of acquiring a specific type of UMV, a UAV-Unmanned Aerial Vehicle target by scanning airspace proximal a condition-sensing station.

In accordance with one aspect of the present technology there is provided an UMV monitoring and control system including;
a communication unit for communicating with condition-sensing stations; detecting unauthorized control taking of the UMV by any operator or program that is not the registered and approved user.
the communication unit in communication with onboard controls and in the UAV example, avionics and configured to instruct the controls/avionics to take compliant action in response to a command from a condition-sensing station.

In accordance with yet another aspect of the present technology there is provided a computer implemented method of managing a lifecycle of a UMV, the method including the steps of:
requesting input of data relating to a UMV;
requesting input of data relating to a UMV user;
comparing the data with compliance thresholds;
providing mission permissions to the UMV and user depending on the comparison results.

In accordance with one aspect of the present invention there is provided a modular system for monitoring mission of a UMV, including a plurality of engines for monitoring position and estimated position.

In accordance with still another aspect of the present technology there is provided a method of scanning specific to the subset of UMVs which are UAV for aerial vehicles, the method including the steps of:
producing a first energy wave of a selected frequency;
producing one or more succeeding energy waves a selected time period after a previous energy wave so that the wave produces a steerable interference with the previous energy wave;
detecting returned energy waves.

In accordance with a yet further aspect of the present technology specific to the subset of UMVs for surface or aerial vehicles, the method including the steps of:
producing a phased array of electromagnetic waves;
controlling phase gaps between successive waves in the phased array to sweep the phased array across a proximal airspace;
detecting returned electromagnetic waves.

In one embodiment there is provided a planar phased array. In one embodiment there is provided a cylindrical phased array. In one embodiment there is provided a conical phased array. In other embodiments there is provided a heterogeneous matrix of phased arrays.

In one embodiment there are provided a matrix of condition-sensing stations producing phased arrays. In one embodiment there are provided homogenous phased arrays, in other embodiments there are provided heterogeneous phased arrays—mixed according to type.

In one embodiment there are provided electromagnetic waves of HF, VHF, UHF, S-band, C-band, X-band, other radio frequencies.

In accordance with a still further aspect of the present technology there is provided a detection system specific to the subset of UAVs including:
a phased electromagnetic wave transmitter which transmits phased electromagnetic waves so as to scan proximal airspace for objects.

In one embodiment the phase electromagnetic wave transmitter is selected from the group comprising: dipole, microstrip, slotted, slotted waveguide, horn, solid state antennae or other suitable type of antenna.

In accordance with one aspect of the present technology there is provided a method of predictive control of a UMV, the method including the steps of:
obtaining in-mission data from a UMV
estimating UMV mission path;
comparing the estimated path with an approved mission path;
instructing some corrective actions in response to a predicted deviation from the approved mission path.

In one embodiment the corrective action is taken from the group consisting of: notifying enforcement agencies, police; notifying user; sounding an alarm at law or other enforcement agencies; instructing guidance/avionics to take corrective or emergency action to return to the approved mission path before the UMI deviates from the approved mission path by a selected tolerance distance.

In one UAV specific embodiment the estimating step is undertaken with a Kalman filter to create a model of the UAV's attitude over time to predict possible future attitudes.

In accordance with another aspect of the present technology there is provided a method of providing condition estimates of UMVs as well as specific to the subset of UAVs, the method including the steps of:
monitoring condition data relating to an unmanned aerial vehicle;
calculating estimates of future condition based on velocity and attitude data.

Separately-defined aspects of an technology have been described herein but it is to be understood that the different aspects and embodiments of the technology can be combined and different elements from different systems can be utilized in other systems described herein even if not explicitly combined herein.

Throughout this specification and the claims that follow, it is to be understood that transmitter-receiver and transceiver are interchangeable terms. That is, whether the transmitter and receiver share components is irrelevant to the operation of any embodiments of the technology.

Throughout this specification, unless the context requires otherwise, the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is solely for the purpose of providing a context for the present technology. It is not to be taken as an admission that any or ail of these matters form part of the prior art base or were common general knowledge in the field relevant to the present technology as it existed before the priority date of each claim of this specification.

In order that the present technology may be more clearly understood, preferred embodiments will be described with reference to the following Figures.

### BRIEF DESCRIPTION OF THE FIGURES

FIG. 1 is a block diagram of a control and monitoring system for monitoring or controlling an unmanned vehicle (UMV) through its off-mission lifecycle and planning as well as in-mission actions in accordance with one embodiment of the present technology;

FIG. 2 is a block diagram of software processes for a condition-sensing station for UMV control and monitoring system in accordance with a component of one embodiment of the present technology;

FIG. 3 is a schematic diagram of data flow between components in a condition-sensing computer processing system in the control station shown in FIG. 2:

FIG. 4 is a schematic diagram of a control centre computer processing system accordance with an embodiment of the present technology;

FIG. 5 is a block diagram of a system for monitoring and/or controlling a UMV in one embodiment termed Life Cycle and Data Management System in accordance with one aspect of the present technology;

FIG. 6 is an example of a relational database configured to store user registration data in accordance with a component of a preferred embodiment of the present technology;

FIG. 7 is an overview of a system for managing lifecycle and data (LDMS 12) in accordance with an aspect of the present technology, generalized for UMVs;

FIG. 8 is an overview of a registration/licensing engine of the LDMS 12, in accordance with one preferred embodiment of the present technology;

FIG. 9 is a schematic diagram showing data flow in the registration/licensing and certification engine shown in FIG. 8;

FIG. 10 is an overview of a manufacturing and mission readiness/airworthiness engine in accordance with one aspect of the present technology, specificaiiy for system embodiments relating to UAVs;

FIG. 11 is a schematic diagram showing data flow between components in the manufacturing and mission readiness/airworthiness engine shown in FIG. 10;

FIG. 12 is an overview of a mission operations and communications engine, being one aspect of the present technology;

FIG. 13 is an overview of a maintenance and repair engine, being one aspect of the present technology;

FIG. 14 is a schematic view of data flow between components in the maintenance engine shown in FIG. 13;

FIG. 15 is an overview of a compliance and safety engine which is one aspect of the present technology;

FIG. 16 shows data flow between system components in the compliance and safety engine shown in FIG. 15;

FIG. 17 shows a decision tree for mission/flight plan approval, a process undertaken in a preferred embodiment of the present technology, using the system shown in FIG. 1;

FIG. 18 shows components of and data flow between components in an analytics engine, which is a component of an aspect of the present technology;

FIG. 19 is a block diagram of components of an onboard computer, to be mounted on a UMV, for facilitating control and monitoring of a UMV;

FIG. 20 shows a distributed architecture of the onboard computer shown in FIG. 19;

FIG. 21 is a side elevation schematic view of a rangefinder for mounting to a UMV/UAV for fadlitating control and monitoring of the UMV/UAV;

FIG. 22 is a front elevation schematic view of visual sensors and rangefinder for mounting on a UAV;

FIG. 23 is a schematic elevation view of a UMVIUAV showing communication systems and GPSS antenna;

FIG. 24 is a schematic isometric view of a UMV/UAV showing mounting of communication antennae;

FIG. 25 is a block diagram of component software processes for a preferred embodiment of a component of the present technology, instructed by the UMV/UAV tart board computer shown in FIG. 19;

FIG. 26 is a block diagram of components and data flow therebetween, for the on board computer shown in FIG. 19;

FIG. 27 is a schematic diagram of a UMV operations condition-sensing station which is one component of the present technology;

FIG. 28 is a schematic layout of a control centre in networked communication with a plurality of conditioning-sensing stations in accordance with one aspect of present technology;

FIG. 29 is a schematic view of an example of a prism planar phased array and expected coverage and gap in accordance with a component of the present technology;

FIG. 30 is a schematic view of coverage with prism radar systems; in accordance with one aspect of the present technology;

FIG. 31 is a schematic view of a cube planar phased array and expected coverage and gap in accordance with one aspect of the present technology;

FIG. 32 is schematic view of a wave coverage analysis with cube radar systems in accordance with one embodiment of the present technology;

FIG. 33 is a schematic view of coverage with a cylindrical conformal phased array and expected wave coverage in accordance with one aspect of the present technology;

FIG. 34 is a schematic view of radar wave coverage with a conformal phased array in accordance with one embodiment of the present technology;

FIG. 35 is a schematic view of planar radar wave coverage in accordance with a preferred embodiment of the present technology;

FIG. 36 is a schematic view of another type of planar radar wave coverage, in accordance with an embodiment of the present technology;

FIG. 37 is a schematic view of a contemplated combination of radar wave systems for greater coverage in accordance with one embodiment of the present technology;

FIG. 38 is a schematic view of a configuration of cameras on a condition-sensing station; and

FIG. 39 is a flow chart showing a process of a preferred method of the technology.

### DETAILED DESCRIPTION OF EMBODIMENTS OF THE TECHNOLOGY

Throughout the description to follow, it may be convenient at times to refer to UAVs but it is to be understood that the technology is applicable to UMVs of all kinds, including terrain-bound vehicles, seaborne vehicles, and other multi-purpose vehicles.

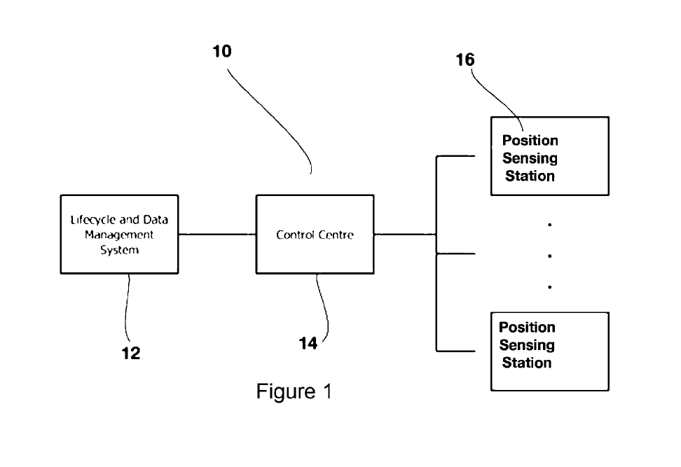

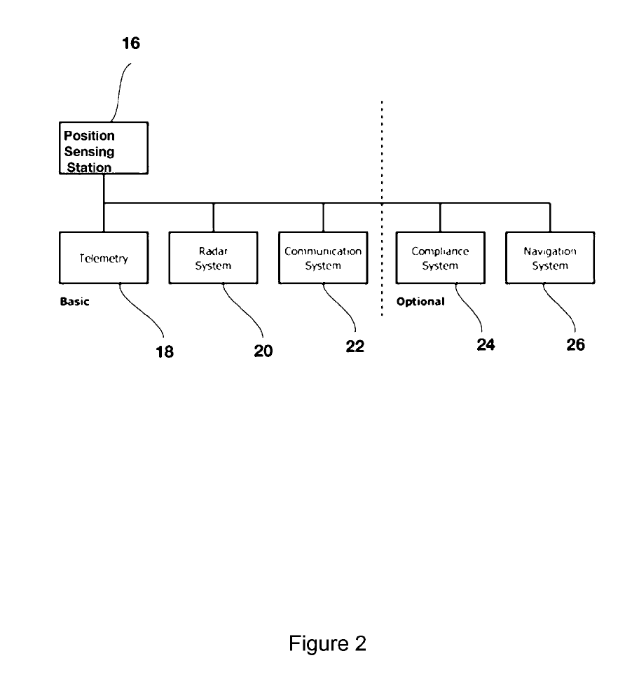

Referring to the FIGS. 1 and 2 there is shown in schematic form an embodiment of the present technology, being a system for monitoring and controlling Unmanned Vehicles, the system generally indicated at 10.

The system 10, also termed an unmanned vehicle operations system 10 or UMV operations system 10, includes one or more condition-sensing station nodes 16. Each condition-sensing station 16 is configured to execute a set of software engines, or engines or processes, using a computer processing system 14 connected to a network. The condition-sensing stations 16 in the UMV Operations System 10 are individually configured to function with varying degrees of independence from the control centre computer processing system 14. The computer system architecture could be executed in a distributed way such that processing resources are shared between the computer processing system 14 and the condition-sensing stations 16, or could be cloud-based wherein the processing resources could be disposed anywhere in the world, connected by a network.

One embodiment of condition-sensing station 16 is configured to scan the surrounding area/airspace with a radar or similar detection system, maintain a communication link with UMVs that are in range of the condition-sensing station 16, maintain a communication link to other nearby condition-sensing stations 16 or the UMV Operations System Control Centre (control centre 14) and send collected telemetry data or logs back to the control centre 14 for storage and processing: engines for such a configuration can be seen in FIG. 2.

A condition-sensing station 16 is configured with optional engines which retrieve approved mission plans of UMVs that pass within its range and makes decisions regarding compliance transgressions or mission deviations or discrepancies independently. The condition-sensing station 16 can be also configured to provide additional navigation information to UMVs in range; these optional system elements or engines can be seen in FIG. 2. Optional engines or processes may be toggled individually for each condition-sensing station by the control centre 14, dynamically increasing or decreasing functionality as necessary. A condition-sensing station 16 acting independently with the optional processes enabled may decrease the load of the communication links.

Detection System Engine (Particularly Useful for UAVs)

The Detection System engine is configured to use one or more sensors to observe some area/airspace around the condition-sensing station 16. If a UMV is detected within the operational range, the Detection system engine is configured to continuously track the condition and/or condition of the UMV until the UMV leaves the operational area. While the UMV is within the operational range, the Detection System engine is configured to provide condition information, for example range and bearing, of the UMV to the onboard computer.

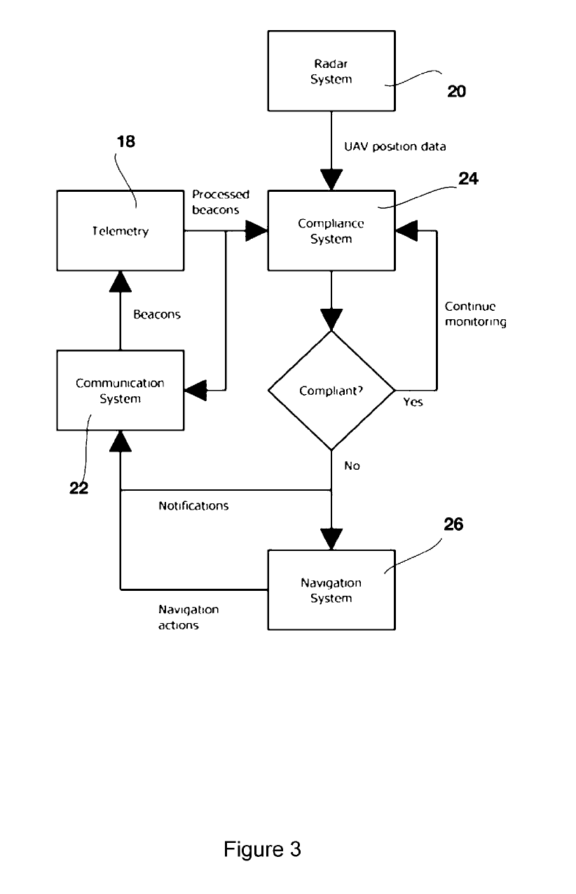

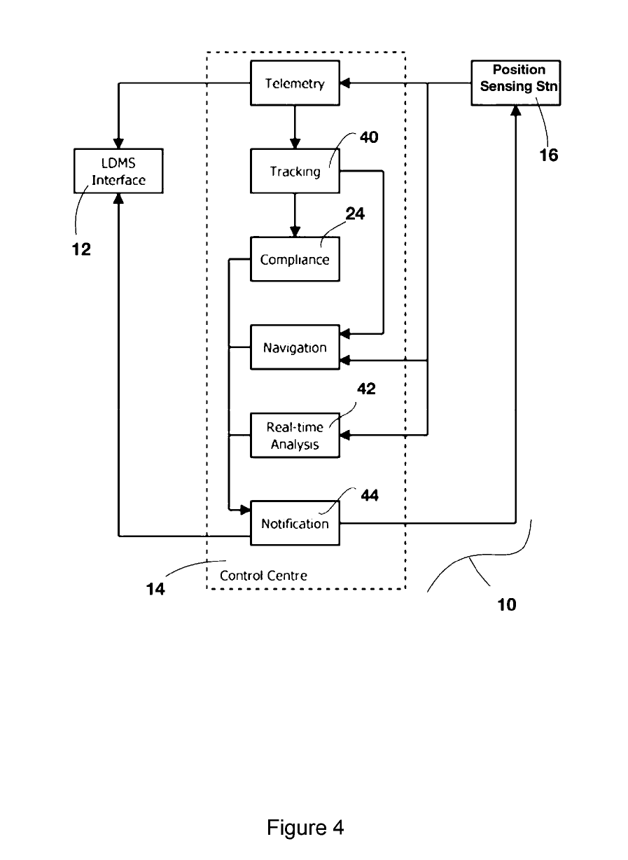

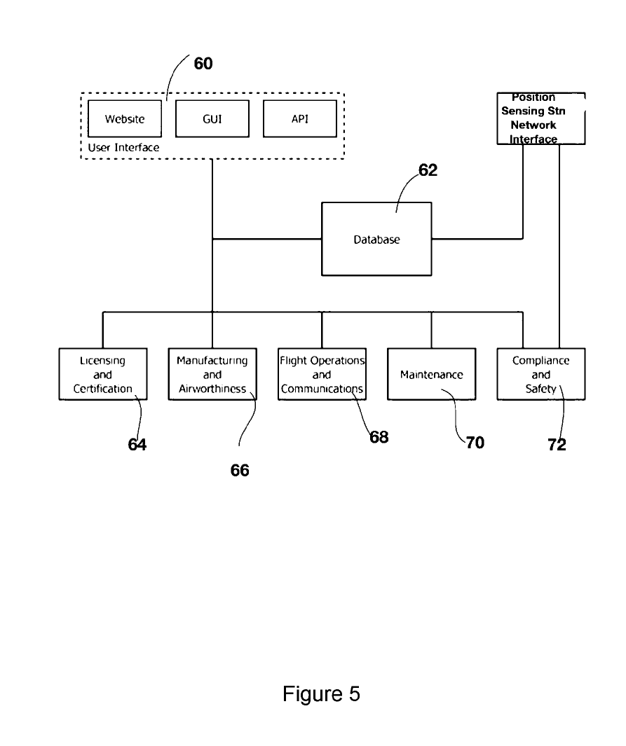

One example, where the condition-sensing station 16 is configured to observe some airspace and the UMV detection system is configured with a radar rangefinder only, is shown in FIG. 3; the Detection System engine, element or engine 20 is configured to scan in the azimuthal range substantially continuously. Once a target UAV has been identified, the Detection System engine 20 is configured to track the target in both azimuth and elevation to maintain an accurate condition estimate of the target UAV. The Detection System engine 20 then is configured to notify the onboard computer of a valid target UAV. The Detection System engine 20 may be configured to also use the signal strength of the return signal to estimate the range to the target.

In another example, where the condition-sensing station 16 is configured to observe some airspace and the UMV detection system is configured with some light-based rangefinder (for example, technologies such as LIDAR, LEDDAR, laser sensing or other multi-spectral capabilities) and a stereo pair of high resolution cameras, the Detection System engine is configured to use image processing algorithms on the visual data captured by the cameras to detect moving objects within the operational area. If a UMV is detected, the Detection System engine is configured to use the visual data to estimate the range and bearing to the UMV. The condition estimate using the visual data may only be approximate so the Detection System engine is configured to scan the area around the estimated position with the light-based rangefinder which can return a much more precise estimate. In some examples, the Detection System engine may be further configured to track the UMV using the light-based rangefinder while processing the visual data to detect additional UMVs. In some examples, the Detection System engine uses an algorithm, for example a sensor fusion algorithm, to combine the position estimate from the visual data, the position estimate from the lidar data and historical position data together to produce an overall more accurate position estimate of the detected UMV.

Communications System Engine

The Communication System engine, (module, element or process) 22 is configured to interrogate a target UAV utilising a UAV network system 30 having a communication link 36 once the condition-sensing station 16 computer processing system has been notified of a valid target UAV. The Communication System engine 22 is configured to periodically interrogate any target UAV in range. Upon receipt of a telemetry packet, the Communication System 22 transfers the data into an appropriate buffer and notifies the Telemetry engine 18; the Communication System engine 22 is configured to transmit data that has been placed in the appropriate buffer by the Telemetry system element engine 18 to the control centre 14. If the engine fails to receive a response from the UMV after interrogation, the engine is configured to periodically (say, every second) retry interrogation and record a fault if that fails. In one example, the engine may send five more beacon requests after the initial request did not receive a response; in this example the communication engine 22 is configured to generate an empty telemetry packet with only the fault with the communication link recorded and transmit that to the control centre 14.

Telemetry System Engine

The Telemetry engine 18 appends additional information to the data collected from the UMV network system 30 before transferring the data back to the Communication System engine 22 for transmission to the control centre 14. For example, additional information may include identification numbers (of the condition-sensing station 16), timestamps, condition data (gathered by the radar system), or others. The Telemetry engine system 18 is configured to send any telemetry it receives substantially immediately to the control centre 14 or configured to store it instead. In some examples, the telemetry engine 18 stores the data while the UMV is still within range of the condition-sensing station 16, and transmits the entire batch once the UMV has left the condition-sensing station 16 range.

In some examples, the condition-sensing station 16 may be configured with the optional Compliance System 24 and Navigation System engines. Both engines are basically the same as described hereinbelow under the headings Compliance engines and Navigation engines, with a few minor differences as set out below:

The Compliance System engine 24 for a condition-sensing station 16 is configured to request, flight plan data from the control centre 14 for detected UMVs within the condition-sensing station's range; in some examples, pre-approved mission plans may be pushed to the relevant condition-sensing stations, by the control centre 14 beforehand. The Compliance System engine 24 is configured to update its mission plan data periodicaliy, for example daily. The engine only calculates compliance for UMVs within the condition-sensing station's range. Notifications are still handled by the control centre 14. Details of breaches are recorded locally, at the condition-sensing station 16, but forwarded to the control centre 14.

Navigation System Engine

The Navigation System engine 26 for a condition-sensing station 16 collects and calculates navigation data from within the range of a condition-sensing station 16, and provides navigation support to UMVs within the range of the condition-sensing station 16. The Navigation system 26 is configured to send navigation data, as well as any actions taken, to the control centre 14. In some examples, where the UMV network system 30 requests navigation support but the condition-sensing station 16 is not configured with the Navigation System engine 26, the request is passed to the control centre 14 directly.

Control Centre

The UMV Operations System Control Centre 14 manages the condition-sensing station 16 network and collects telemetry data from UMVs fitted with the UMV network, system 30 via the network; the control centre 14 then processes the collected data and passes both the processed and raw data to the UAV Operations System Lifecycle and Data Management System (LDMS 12) through the LDMS 12 interface. The interface between the control centre 14, and therefore the condition-sensing station 16 network, and the LDMS 12 may be physical or logical. In some examples, where the control centre 14 and LDMS 12 share the same facility, the interface may simply be a software interface that allows the control centre 14 to deposit data in the LDMS 12 database. In other examples, where the control centre 14 and LDMS 12 are in different facilities, the interface may be a physical communication link, for example, over the Internet.

The control centre 14 contains software processes to collect and process telemetry data as well as provide active control of the condition-sensing station 16 network in the appropriate situations. These processes are discussed further below:
a. Telemetry 18
b. Tracking 40
c. Compliance 24
d. Navigation 26
e. Real-time analysis 42
f. Notification 44

Telemetry Engine

The telemetry engine 18 is configured to collect and provide temporary storage for incoming telemetry data packets from the condition-sensing station 16 network communication link. The telemetry engine 18 may be configured to sort the telemetry data packets into an order since they will arrive in a disorderly manner. In some examples, the telemetry engine 18 is configured to organise the data packets in order of the condition-sensing station 16 it was sent from. In other examples, the engine is configured to organise the telemetry data packets by associated timestamps. The engine is configured to pass the telemetry data collected to the Tracking, Navigation and Real-time analysis engines as well as the LDMS 12 through the LDMS 12 interface. In some examples, where the engine sorts the telemetry data packets, the telemetry data packets are passed onto other engines after sorting.

Tracking Engine

The Tracking engine 40 is configured to use telemetry data packets from the condition-sensing station 16 network to track the movement of all UMVs within the condition-sensing station 16 network. The engine is configured to utilise both the telemetry data collected from the UMV network system 30, which is transmitted to the condition sensing station 16 network, and the additional information added by each condition-sensing station 16 to track the UMVs.

Telemetry data from the UMV network system 30, for example GPS coordinates or altitude, is used by a tracking engine computer processing system to generate a path through the area covered by the condition-sensing station 16 network. The path may be in a global or local set of coordinates. In one example, latitude, longitude, altitude, coordinates may be used. In another example, a local reference frame centred on the control centre 14 may be used. The tracking engine 40 will also use the data collected by the condition-sensing station 16 UMV Radar System to calculate a path. In one example, the range, azimuth, elevation data from the UMV Radar System of a particular condition-sensing station 16 will be used in an estimation algorithm to calculate the path of the UMV through that condition-sensing station 16's coverage; in this example, the Tracking engine 40 may then combine the calculated paths from successive condition-sensing stations to detemiine the overall mission path.

In the event of a discrepancy between the path calculated using the UMV network system 30 data and the path calculated using the UMV Radar System data, the tracking engine 40 will rely on the path using the data from the UMV Radar System; the engine will store both paths and flag the discrepancy as a fault For example, the discrepancy may be caused by a lack of GPS data from the UMV network system 30; in this example the fault may be recorded as a problem with the onboard GPS engine.

Compliance Engine

The Compliance engine 24 is configured to request mission plans from the LDMS 12 using the LDMS 12 interface. In one example, the compliance engine 24 requests an approved mission plan as soon as a new UMV 50 is detected by the condition-sensing station 16 network. In another example, the engine is configured to request a batch of all approved mission plans for that day. The compliance engine 24 is configured to compare actual mission paths of tracked UMVs as calculated by the Tracking engine with submitted mission plans for that UAV 50 to check whether that UMV 50 is compliant with the relevant laws and regulations.

If a breach or discrepancy is detected, the compliance engine 24 may instruct the issuance of an alert or instruct that action be taken based on the severity of the UMV 50 course deviations. Alerts are handled by the Notification engine 44. In some examples, where the infraction is minor, for example the UMV 50 drifts away, for example <1 km, from the submitted mission plan, the compliance engine 24 may simply instruct the notification engine 44 to issue a warning to the pilot or UMV 50 owner in real-time. In other examples, where the UMV 50 continues to stay off its original mission plan, the control centre 14 is instructed to take over the control of the UVM 50, via the UMV network system 30, and force the UMV 50 back to its original flight path or an emergency contingency path. In another example, where a detected UMV 50 is unable to be identified, an appropriate enforcement body may be notified by the compliance engine 24 to send a craft or unit to follow the UMV 50.

If a breach is detected by the compliance engine 24, the engine 24 sends details of the breach to be recorded. Details may include, for example, UMV 50 registration numbers of UMVs involved, type of breach, duration of breach or other details. Breaches may include, for example, deviation from planned flight paths, unauthorised altitudes or collisions, unauthorized takeover of communication or navigation signals; in some examples, near misses, for example with another UMV 50 or a static obstacles, may also be recorded as a ‘breach’. The compliance engine 24 also consolidates and records any faults that had been noted by the UMV network system 30, or an individual condition-sensing station 16. In one example, an individual condition-sensing station 16 may have noted a communication link failure; in this example the engine may generate an empty ‘breach’ report to ensure the fault is recorded by the LDMS 12. In another example, the UMV network system 30 may have noted a sensor failure, for example a camera used for visual or other electromagnetic frequency navigation; in this example, the Navigation engine 26 may be notified by the compliance system 24 as well as an empty ‘breach’ report being generated. The details of all breaches are provided to the LDMS 12, through the LDMS 12 interface, for further processing or review and storage.

Navigation Engine

The Navigation engine 26 is configured to provide additional navigation support to UMVs within the condition-sensing station 16 network. In some examples, where a UMV 50 is approved to operate in a corridor rather than a strict mission path, the navigation engine 26 may be used to help plot a local path through that corridor for the UMV. In other examples, where a large amount of congestion is detected in a particular area, the navigation engine 26 may temporarily approve deviation from a mission plan to guide UMVs through congested areas.

The Navigation engine 26 is configured to use local maps and UMV telemetry and traffic data to determine ‘safe’ operations/airspace within the range of individual condition-sensing station 16s. Local maps may be stored in a memory. The navigation engine 26 may be configured to update the stored local maps. The navigation engine 26 may be further configured to process the data to generate navigation insights These insights may include for example, relative positions of UMVs in range of an individual condition-sensing station 16, positions of static obstacles or other data that may aid the UMV 50 in avoiding collisions. The navigation engine 26 may also be configured to generate this information for each individual condition-sensing station 16 in the network; the engine may be further configured to provide this information to the relevant condition-sensing station 16.

The navigation engine 26 may be configured to provide either navigation data or specific actions to any UMV 50 at the request of the onboard UMV network system 30 for whatever reason. In some examples, where a UMV 50 in range of an individual condition-sensing (ground) station 16 needs supplementary data, the engine may provide the UMV 50 with the navigation data the engine collects. In another example, where the UMV network system 30 is configured to provide navigation actions tut one or more faults have occurred in the UMV network system 30, the Navigation engine 26 may be configured to provide, through the condition station 16 network, specific and secure navigation actions to the UMV 50 to guide the UMV 50 to a ‘safe’ area or facilitate adherence to the original mission or emergency/contingency plan. In some examples, where the control centre 14 has been configured to take over the UMV 50 to force compliance in the event of a breach, the Navigation engine 26 may be configured to calculate actions to restore compliance or if such actions are impossible, determine a ‘safe’ area to force the UMV 50 to land consistent with registered and approved emergency/contingency plans. In these examples where the navigation engine 26 is configured to independently provide navigation actions, the navigation engine 26 may be configured to record all actions taken for review. This recorded data may be rendered into a service to provide evidence if there are disputes which arise based on UMV usage. Navigation data, as well as records of actions taken, are provided to the LDMS 12 for storage and, in some examples, for review.

Real-Time Analysis

The Real-time Analysis engine 42 is configured to process telemetry data in real-time to determine trends or patterns that may affect the operation of UMVs within the condition-sensing station 16 network. The Real-time Analysis engine 42 uses algorithms to process all data from the Telemetry and Tracking engines. In one example, the Real-time Analysis engine 42 may use sensor data in the telemetry to detect unusual weather or current patterns. In another example, the Real-time Analysis engine 42 may use the rate of communication link faults to detect radio interference or attempts to hijack the communications and control of a UMV. In another example, the Real-time Analysis engine 42 may use mission path data from the Tracking engine to detect areas of high traffic. In these examples, the Real-time Analysis engine 42 may issue a warning to notify affected areas or provide the data to an traffic (air, sea, land) authority; notifications are handled by the Notification engine 44.

Notification Engine

The Notification engine 44 is configured to issue notifications to users, UMVs, authorities or other affected parties at the request of the other engines or a third party. In one example, a traffic authority may wish to issue a real-time notice regarding, for example, hazardous weather, temporary airspace restrictions, airport closures or congestion, rough seas, military operations which may impeded the mission path; in this example the Notification engine 44 may issue the warning on their behalf over the condition-sensing station 16 network communication links. In another example, the Compliance engine 24 may request to issue a notice to a user for a compliance breach. In another example, the Real-time Analysis engine 42 may request to issue a warning regarding an insight.

The Notification engine 44 may use the LDMS 12 interface to query the LDMS 12 database to retrieve contact details of users; for example, email addresses. It may use these contact details to issue the notification; for example, in the event of a compliance breach or the detection of unusual weather or other things which could impact the mission plan. The Notification engine 44 may be configured to also issue notifications over the condition-sensing station 16 network to affected condition-sensing station 16s.

In one example, where there is an area of high congestion, the Notification engine 44 may issue a warning to affected condition-sensing station 16s and pass navigation data from the Navigation engine 44 as well. In another example, the Notification engine 44 may use the wireless communication links of the condition-sensing station 16 network to issue the warnings to pilots or navigation systems.

Lifecycle and Data Management System (LDMS 12)

The UAV Operations System Lifecycle and Data Management System (LDMS 12) is a computer implemented method of monitoring or controlling an unmanned vehicle (UMV) through its off-mission lifecycle and planning as well as in-mission actions, the method including the steps of:
interrogating a UMV for identification data;
comparing the UMV identification data with data associated with that UMV taken from the group consisting of. registration, licensing, certification, manufacturing and airworthiness, flight operations and communications, mission and emergency pans, maintenance, compliance and safety;
taking a relevant action in response to the data comparison In embodiments, there is provided a software system that is configured to store and analyse the data the UMV operations system 10 collects. The data may be collected via direct input into the UMV Operations System, i.e. a user interface, via the UMV Operations System condition-sensing station 16 network, or other means of data collection. The LDMS 12 collects data to ensure safe lifecycle management and operation of UMVs and may provide the information it collects to interested parties which may include, but is not limited to, commercial interest, regulators, industry watchdog groups, law enforcement, civil interest groups, insurers or other parties.

The UAV Operations System LDMS 12 is configured to provide a user interface 60 to allow entry of relevant information by users into the system. Relevant information may be related to users, UMVs, flight plans or other information; in addition a user may interact with the user interface 60 in order to retrieve certain information, for example, about the user, about a particular UMV 50, a particular mission plan or other information.

The user interface 60 may be, for example, configured as a website that users may access remotely over the Internet. The website may contain a series of webpage forms to collect information from users; users may also navigate the website to query the LDMS 12 and retrieve desired information. In other examples, the user interface 60 may be configured to be an application with a graphical user interface (GUI) that can be downloaded and/or installed onto a user's computer or mobile computing device. The GUI may contain a form to collect user information and transmit it to the LDMS 12; the GUI may also contain a series of buttons and menus to retrieve desired information from the LDMS 12. In some examples the user interface may be configured to include an application programmable interface (API). The API allows users to perform more advanced queries of the LDMS 12 or automated queries; for example, an insurer may use the API to collect fault rates of a particular type of UMV 50 and automatically keep this information updated as new data is added.

The LDMS 12 is also configured with an interface to the UMV Operations System condition-sensing station 16 network. This interface allows interaction with the UMV Operations System condition-sensing station 16 network; the LDMS 12 can use this interface to collect incoming telemetry packets from the condition-sensing station 16 network over the condition-sensing station 16 network communication link. These telemetry packets may be stored in the LDMS 12 database for further analysis. In some examples the control centre may partially or fully process the telemetry packets to aid the operation of the condition-sensing station 16 network; in these examples, the LDMS 12 is configured to collect both raw data packets and the processed data.

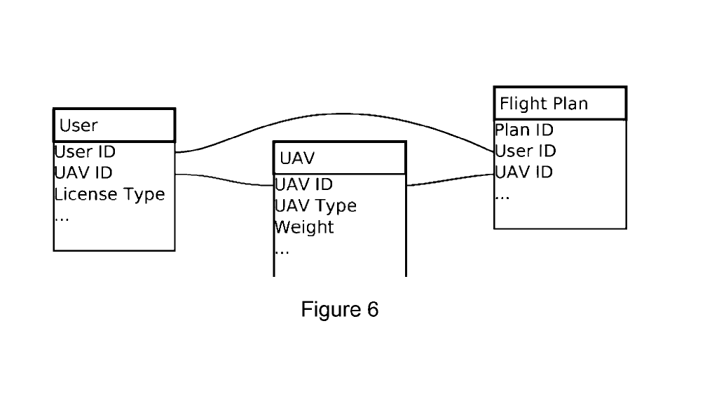

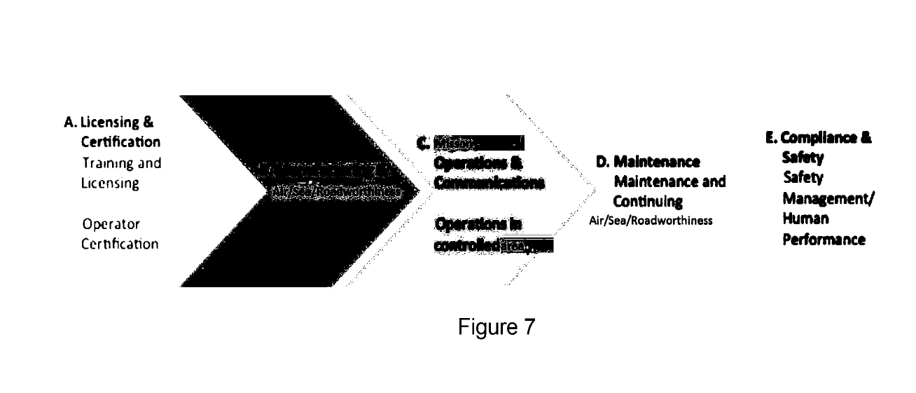

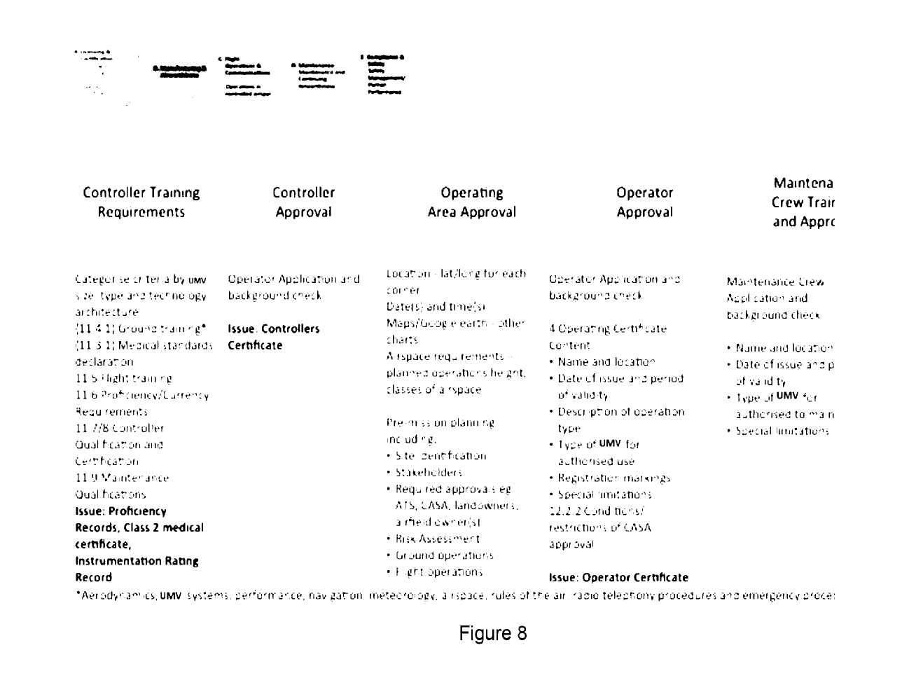

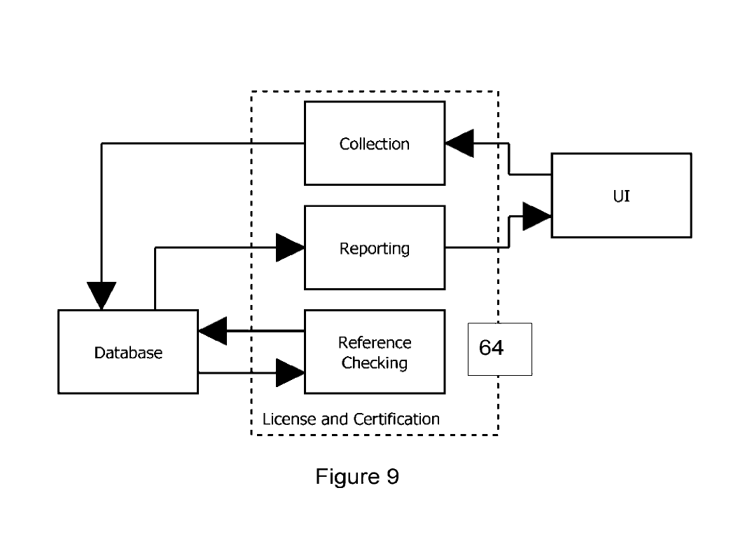

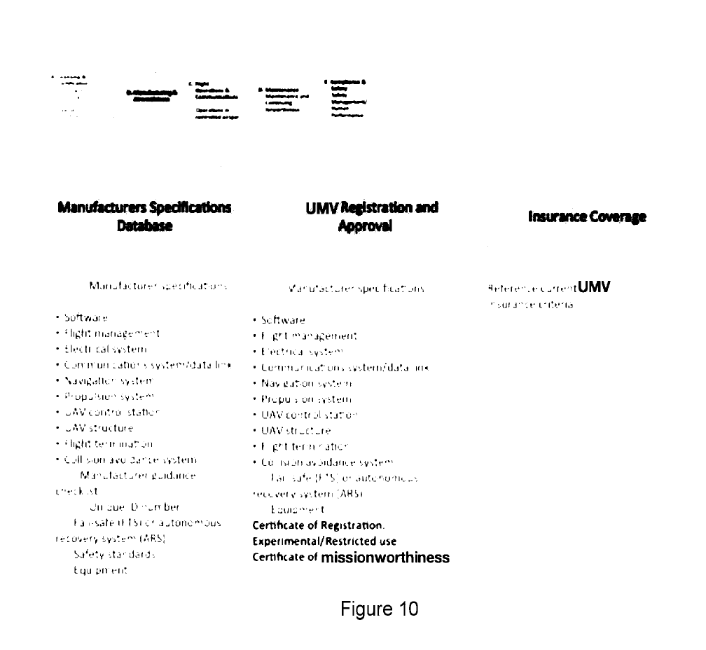

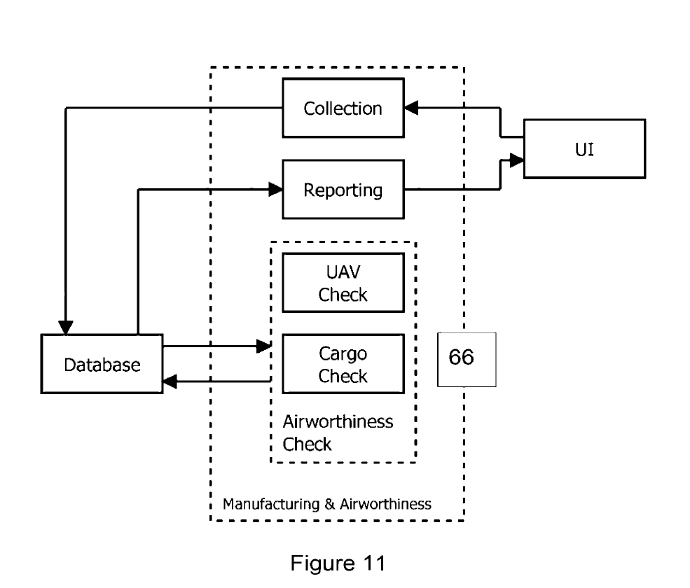

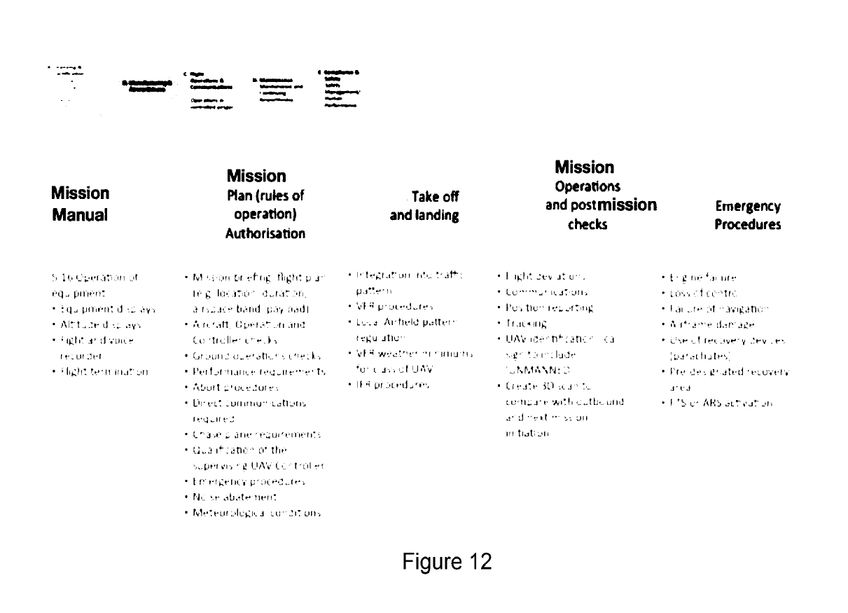

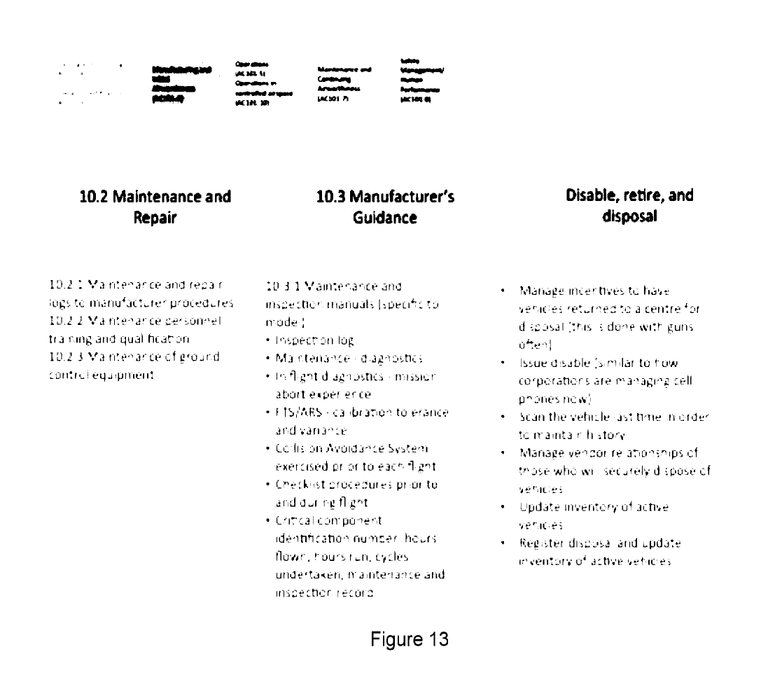

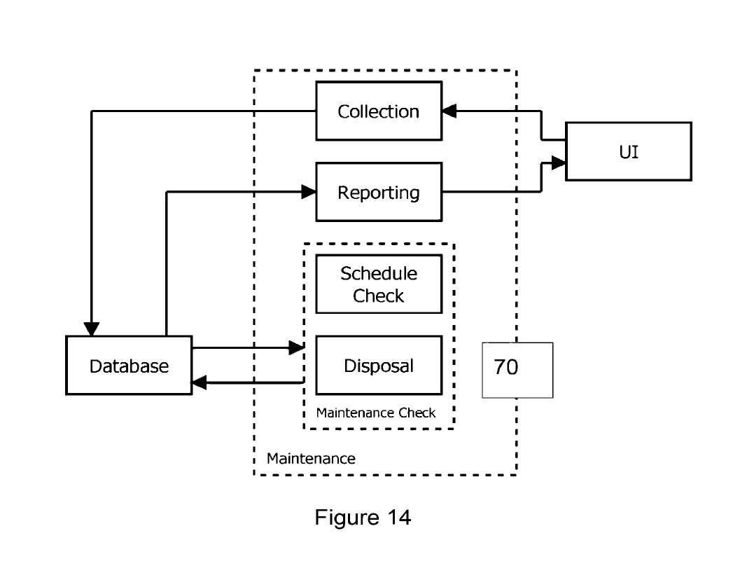

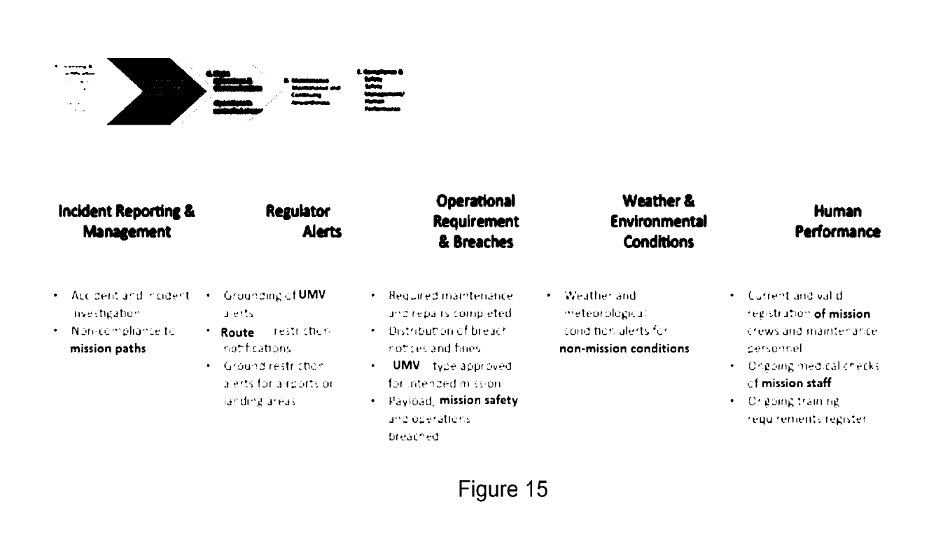

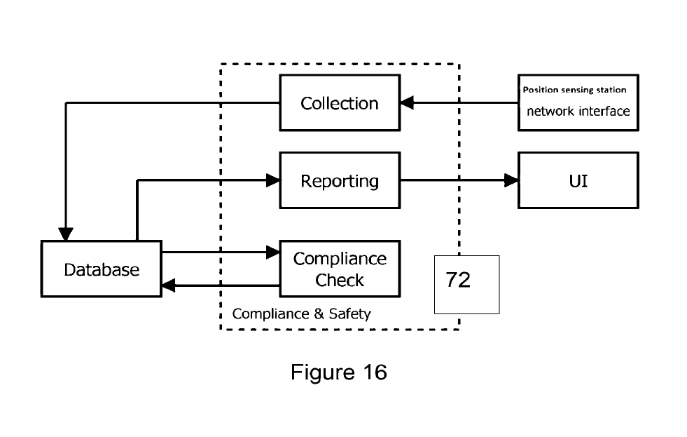

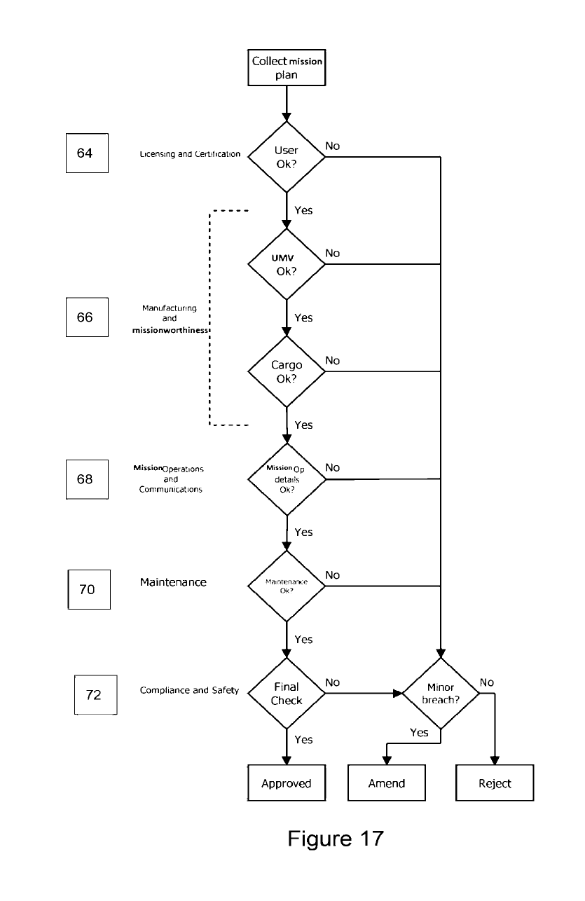

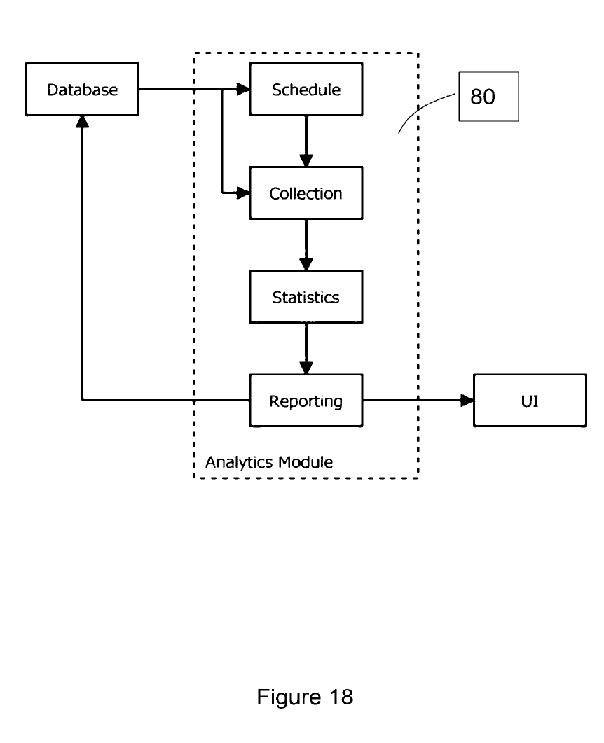

The data collected through the user interface 60 and the condition-sensing station 16 network interface may be stored in a database 62; for example, the database 62 may be configured as the relational database in FIG. 6, or other suitable database configurations. Database management software may be used to manage the database, for example MySQL or Microsoft Access software.

Through interactions with the user interface 60, users are able to create unique accounts which will uniquely identify each user; users may be individual or corporate. The user accounts will have an identification number that will be referenced in all future interactions between the LDMS 12 and that user; these accounts are stored in the LDMS 12 database, User accounts contain information about the user which may include, but is not limited to:

User registration number

Type

Name

Contact details

Biliing details

Registrations, licenses and certifications

UMVs owned and performance/compliance records

Other information relevant to the user

Users are also able to register individual UMVs which are also given an identification number so that each registered UMV 50 may be uniquely identified; these accounts are stored in the LDMS 12 database. In one example, the user may use the user interface to register a particular UMV 50 by a serial number given to it by the manufacturer; in this example, the LDMS 12 may be configured to associate an identification number with the manufacturers serial number, thus allowing the LDMS 12 to trace the UAV 50 to a particular manufacturer. Each UMV 50 account contains information about the UMV 50 which may include, but is not limited to:

UAV registration number

Manufacturer

Type, communications and navigation details

Weight

Current owner and ownership history

Maintenance schedules

Cargo capacity and typical payload characteristics

History of faults, if any

Other information relevant to the UAV

Once a UMV 50 has been registered, users may submit mission plans utilising that UMV 50 to the LDMS 12 for approval; users must have approval before they are permitted to operate a UMV 50. Mission plans include ail information related to the operation which may include, but is not limited to:

Flight plan reference number (given by the LDMS 12 on submission)

User registration number (that submitted the flight plan)

UAV registration number (which is to be utilised by the flight plan)

Pilot registration number (if applicable)

Notification of ‘special’ flights; for example, test, certification or inspection flights

Payload/cargo manifest

All flight segments including intermediate destinations, waypoints and final destination coordinates; for example, in latitude and longitude

Estimated departure and arrival time

Target altitude if appropriate; for example, if in shared airspace

Communications frequencies/channels, and communication security details

Nearest acceptable landing area in an emergency or a suitable contingency/emergency plan if appropriate

Other information relevant to the flight plan

The LDMS 12 is further split into five engines which facilitate observance of all the relevant laws and regulations by users. In terms of UMVs and mission plans; non-compliance may result in certain actions by the LDMS 12, for example issuing a fine, or decommissioning or disabling the UMV. These five sections are further discussed below:

Registration, Licensing and Certification

Manufacturing and Airworthiness

Flight Operations and Communications

Maintenance

Compliance and Safety

Registration, Licensing and Certification

The Licensing and Certification engine 64 utilises the collected user registration data to establish a data trail for accountability for all potential users of the UMV operations system 10. Potential users of the system may include:

Commercial UAV operators

Pilots

Manufacturers

Third party parts suppliers

Mechanics or maintenance personnel

Vehicle/payload verification/certification specialists

Training schools or facilities, insurance companies, and other enforcement agencies

The Licensing and Certification engine 64 keeps track of the registrations, licenses or certifications that a user owns; the licenses or certifications are collected via the user interface and stored in the LDMS 12 database and associated with the user's account. In one example, a commercial UMV operator may only own a license to operate UMVs of a certain weight class. for example less than 100 kg. In another example a pilot or operator may only own a license to operate below a certain altitude, for example below 100 m; in this example the pilot, may also have other aircraft or instrument ratings/certifications associated with their user account. The engine may collect the data by using a form configured appropriately for the user interface. In examples where the user interface is a website, the engine may collect the data using another separate webpage form. In examples where the user interface is a GUI, the form may be a separate window. The engine may be further configured to access external systems to retrieve certification data. For example, a regulator, insurer, or enforcement agency may have an existing database, with an API, of UMV operators it has certified; in this example, the engine may use the API of the external system to retrieve the certification data and associate the data with the regulators' user accounts.

The Licensing and Certification engine 64 provides online reference checking to ensure any and all legal or regulatory obligations are>met by users. The Licensing and Certification engine 64 checks the user account for the appropriate approvals before allowing certain actions. The Licensing and Certification engine 64 queries the database to retrieve the relevant user data and uses an algorithm to decide whether or not an action should be approved. In one example, a commercial UMV operator may not be allowed to operate any UMVs (or even submit any mission plans) until a mandatory safety induction is completed and noted in their user account. In another example, an operatorfpilot may not be allowed to operate a UMV (i.e. the mission plan is denied) until an appropriate medical approval has been obtained and noted in their user account. In another example, a commercial UMV operator may not be permftted to purchase a UMV from a registered UMV retailer until they are registered themselves and have obtained an identification number from the LDMS 12 that the operator can supply to the retailer; in this example the commercial UMV operator may be further restricted to only purchasing UMVs of a certain weight class or capability, for example less than 100 kg, unless they have associated the appropriate license with their user account. The Licensing and Certification engine 64 may be further configured to provide cross checking between users to automatically update licenses and certifications. For example, a registered operator/pilot training school may record a list of its graduates with the LDMS 12; in this example, the Licensing and Certification engine may automatically update the user accounts of those students with their new certification.

The Licensing and certification engine 64 allows users to access and view licensing data via the user interface; the engine may also be configured to generate a report using the data. Different users may have access to a greater or lesser amount of data depending on the type of account, i.e. there are varying levels of permissions. The engine queries the database to retrieve the requested information then passes the information to the user through the user interface; if the user requests data that they are unauthorised to access, an error message may be returned instead. In one example an individual may have access to their own account only to view a summary of their licenses or certifications. In another example a commercial UMV operator may be permitted to view certain account details of its operators/pilots to ensure all are suitably qualified for the aircraft the operator is licensed to operate. In another example the enforcement agency or regulator may be permitted to view certain account details of all users to determine popular license types. In these examples, only licensing and certification data are available to be viewed.

Manufacturing and Mission Worthiness

The Manufacturing and Mission worthiness engine 66 collects information related to the operation of the UMV to track each individual UMV 50 over its entire lifetime; this information may be collected via the user interface and is stored in the LDMS 12 database. In one example, the Manufacturing and Mission worthiness engine 66 tracks individual UMVs over all current and future owners beginning with the manufacturer. The Manufacturing and Mission worthiness engine 66 may collect the data by using a form configured appropriately for the user interface. In examples where the user interface is a website, the Manufacturing and Mission worthiness engine 66 may collect the data using another separate webpage.

UMV types (i.e. a product line) must meet certain design and safety requirements before being allowed to be sold; once the manufacturers have met these requirements and the enforcement agency or regulator has given approval, complete specifications of that UMV type, including all identification/serial numbers of parts, may be registered with the LDMS 12 by the manufacturer or regulator. The Manufacturing and Mission worthiness engine 66 may be further configured to access external systems to retrieve certification data. For example, the regulator may have an existing database, with an API, of approved UAV types that it has already certified; in this example, the Manufacturing and Mission worthiness engine 66 may use the API of the external system to retrieve the UAV specifications and update the LDMS 12 database. Once an approved UMV type has been registered, individual UMVs of that type may be registered with the LDMS 12. In one example, a manufacturer may register individual UMVs with the LDMS 12 before sale; in this example, the UMV account oniy needs to be updated after the UMV has been sold. In another example, the user that purchased the UMV 50 may register the UMV 50; in this example the user must create a new UMV account.

The Manufacturing and Mission worthiness engine provides online mission worthiness checking to ensure UMVs are safe and fit to operate on a mission. If a user wishes to use a UMV in an operation, the Manufacturing and Mission worthiness engine 66 queries the database to check that the UMV 50 has been registered, has an approved manufacturer serial number associated with the UMV account and has a registered user as its owner; UMV accounts must always be associated with a registered user account. if any of this information is absent, the engine may deny the mission plan. The Manufacturing and Mission worthiness engine 66 may be further configured to check other information related to the mission worthiness of the UMV before approving its use in an operation. In one example the Manufacturing and Mission worthiness engine 66 may query the database to check if the UMV 50 has any outstanding faults; in this example, only once faults have been resolved in an adequate manner is the UMV 50 permitted to be used in an operation. In another example the Manufacturing and Mission worthiness engine 66 may check whether the UMV 50 has an appropriate level of insurance cover; in this example the mission plan utilising the UMV 50 may be denied until an appropriate level of insurance has been obtained by the user.

The Manufacturing and Mission worthiness engine 66 may be further configured to provide online payload/cargo manifest checking to ensure that the cargo is safe and that the UMV 50 utilised is rated to carry the cargo. All cargo must be accounted for in a mission plan manifest and certified by a registered cargo handler (verified by the Licensing and Certification engine). The handler must check, acknowledge and record cargo as safe; the engine checks that these certifications have been submitted by the handler before approving a UMV 50 with cargo as mission ready. For example, some of the safety checks may include:

Cargo weight within UMV tolerances

Center of gravity when loaded within UMV tolerances

No munitions or restricted items without express permission from authorities

No dangerous or hazardous materials without proper licenses or authorisation

Visual record of the cargo if appropriate, and security of communications and navigation confirmed

The Manufacturing and Mission worthiness engine 66 allows users to view certain information related to the operation of an individual UMV 50 via the user interface; the engine may be further configured to generate a report, or series of reports to clearly display this information. The Manufacturing and Mission worthiness engine 66 may be configured to provide different levels of access to the information for different users. In one example, a commercial UMV operator that owns a registered UMV may be permitted to access all stored information regarding that UMV. In another example, an insurer may be permitted to access data regarding the incident of faults for all UMVs of a particular UMV type; in this example the insurer may use this data to inform decisions regarding insurance premiums. The Manufacturing and Mission worthiness engine 66 queries the database to retrieve the requested information then passes the information to the user through the user interface; if the user requests data that they are unauthorised to access, an error message may be returned instead.

Mission Operations and Communications

The Mission Operations and Communications engine 68 provides online mission planning service that may be used by users to submit mission plans to the LDMS 12. The Mission Operations and Communications engine 68 may collect mission plan data by using a form configured appropriately for the user interface. In some examples, where the user interface is a website, the Mission Operations and Communications engine 68 may collect the data using another separate webpage. In some examples, where the user interface is an application with a GUI, the mission planning service may be an application add-on that sends the collected data to the Mission Operations and Communications engine 68, Collected mission plans are stored in the LDMS 12 database arid given to a Compliance and Safety engine 72 for further review.

The Mission Operations and Communications engine 68 provides a reference checking service to ensure all details related to mission operations in a mission plan are compliant with the necessary laws and regulations Details related to mission operations may include, for example, flight segments, target altitudes, communication channels or other details. The LDMS 12 contains records of any restrictions traffic authorities have placed on the mission paths. For example, an air traffic authority may have restricted UAVs above a certain weight class, for example >50 kg, to certain geo-referenced flight corridors. The Mission Operations and Communications engine 68 queries the database to retrieve these restrictions to check if a mission plan is compliant with the regulation. In some examples these restrictions may be integrated into the mission planning service. For example, if a user attempts to enter a waypoint in a restricted area, an error is returned instead.

The Mission Operations and Communications engine 68 also checks planned payloads (not cargo) against any existing regulations. For example, there may exist regulation restricting (or requiring approval for) remote sensing over an urban environment. In one example a flight plan for a commercial UAV operation may include a radar system for scanning terrain and a flight path partially over private property; in this example approval from an appropriate authority and landowners may be required. In another example, a flight plan may wish to include downward pointing cameras for imaging purposes; in this example, the UMV 50 may be restricted to operate above a certain altitude, for example >100 m, Mission plans involving special or complex operations, for example remote sensing, will not be approved until the proper authorisation has been recorded.

The Mission Operations and Communications engine 68 keeps track of mission plans that are eventually approved to estimate congestion. If many mission plans are approved in a particular area, for example a single flight corridor, the engine may reject further mission plan submissions with flight paths in that area to avoid excessive and potentially unsafe congestion. For example, if more than 100 mission plans are already approved using a route between two regional airfields and are operating on the same day, the Mission Operations and Communications engine 68 may reject further flight plans using that route on that day.

Maintenance

The Maintenance engine 70 handles maintenance records of each UMV 50, including maintenance schedules, and provides notifications to users of any maintenance issues. The Maintenance engine 70 may collect maintenance data by using a form configured appropriately for the user interface. In examples where the user interface is a website, the Maintenance engine 70 may collect the data using another separate webpage. In examples where the user interface is a GUI, the form may be a separate window. For example, a registered mechanic may be required to record maintenance data when they service a UMV 50; the data may include, but is not limited to:

User registration number (of the mechanic)

UAV registration number

Job number

Time until next required maintenance; for example, by hours flown or by a certain date

Identification of replacement parts; for example, serial numbers, barcodes or RFID tags

Identification of parts replaced and reasons for replacement for example, serial numbers, barcodes or RFID tags; for example, fatigue or defective

Structural modifications of vehicle or airframe from manufacturers' registered standard (if applicable)

Software modifications from manufacturers' registered standard (if applicable)

The Maintenance engine 70 may query the database to retrieve maintenance schedules for all registered UMVs to ensure all UMVs have undergone regular maintenance and to determine which UMVs are in need of maintenance in the near future. In one example the Maintenance engine 70 may only check the schedule as noted by a registered mechanic. In another example, the Maintenance engine 70 may enforce an regular inspection for all UMVs if no other schedule exists. If a UMV is found to have an inspection scheduled in the near future, the engine may send a notification to the owner; in one example, the notification may be an email reminder. The Maintenance engine 70 may deny the use of the UMV 50 in operations if the maintenance history of the UMV 50 is unsatisfactory. In one example, where a UMV 50 has an upcoming inspection scheduled but has had regular maintenance prior and no history of faults, the Maintenance engine 70 may simply flag the UMV account and send a notification to the owner. In another example, where the maintenance history has been sparse and no inspection has been conducted in over a year, the Maintenance engine 70 may ground the UMV 50 until an inspection has been performed by a registered mechanic.

The Maintenance engine 70 may be further configured to record the retirement or disposal of UMVs once they have reached the end of their useful lives. UMVs must be disposed of at certified disposal centers (verified by the Licensing and Certification engine) and the disposal is recorded by the Maintenance engine 70; in this way the LDMS 12 has kept track of the UMV 50 through its entire lifecycle, from the manufacturer to disposal. The Maintenance engine 70 may also collect serial numbers of all parts that have been disposed of as well as any parts that have been reconditioned and/or submitted for resale. Repositioned parts may be flagged by the engine to provide an additional warning to maintenance personnel if they are reused. The Maintenance engine 70 may request a UMV account be archived after the UMV has been recorded as retired; that UMV account is no longer valid for any mission plans.

The Maintenance engine allows users to access and view maintenance data via the user interface; the engine may be further configured to generate a report or a series of reports to clearly display the data. The Maintenance engine 70 may be configured to provide different levels of access to the information for different users. The Maintenance engine 70 queries the database to retrieve the requested information then passes the information to the user through the user interface; if the user requests data that they are unauthorised to access, an error message may be returned instead, in one example, a UMV owner may be able to access maintenance data for the owned UMV only. In another example, a registered mechanic may be permitted to access the full maintenance history of an individual UMV. In another example a manufacturer may be permitted to access all maintenance data on registered UMV types that it has produced to inform ongoing research and development, in another example insurers or regulators may be permitted to access maintenance data across all UMV types to assess potential risk areas.

Compliance and Safety

The Compliance and Safety engine 72 ensures that all submitted mission plans abide by the relevant laws and regulations and contain no, or minimised, safety risks. The Compliance and Safety engine 72 checks with all other engines: the License and Certification engine 64, the Manufacturing and Mission worthiness engine 66, the Mission Operations and Communication engine 68 and the Maintenance engine 70 to determine whether a mission plan is compliant and thus should be approved or rejected. Examples of possible compliance breaches from these engines include:

No insurance

UMV requires maintenance/inspections

UMV deemed not airworthy after maintenance

Regulator grounding a particular UMV type

Business, associated with a user account, has been deregistered

Operator/Pilot not approved for particular UMV type

Pilot or UMV not approved for particular payload handling

Pilot or UMV has outdated registration details: for example outdated licenses

Mission path or altitude not approved for particular UMV type

Payload is uncertified, or prohibited

In addition, the Compliance and Safety engine 72 may be configured to further consider:

Unpaid fines by the user

Weather conditions deemed unsafe

If a mission plan is compliant, the Compliance and Safety engine 72 may approve the mission plan, and the user is then authorised to operate their UMV as outlined in the mission plan. If the mission plan is non-compliant, the Compliance and Safety engine 72 may request amendments or reject the mission plan outright. In one example, a commercial UMV operator may have let their insurance lapse but their mission plan is otherwise compliant; in this example the mission plan may be stored, marked as pending, and approval given once the insurance is renewed. In another example a commercial UMV operator may be requesting to use a type of UMV it does not have the license to operate; in this example the mission plan may be rejected and require resubmission after the operator acquires the correct license. In these examples, and other examples, mission plans that are not rejected, for example approved or pending, are stored in the LDMS 12 database.

In the event of a decision (approve, amend, reject etc.), the Compliance arid Safety engine 72 sends a notification to the user of that decision. In one example, where the mission plan only involves a small UMV, for example 10 kg, over a short distance, for example <2 km, carrying no cargo in non-shared airspace, the Compliance and Safety engine may be able to provide approval immediately and notify the user via the user interface. In another example, where the mission plan involves carrying hazardous material, the Compliance and Safety engine may be configured to wait for authorisation from the relevant authority or enforcement agency; in this example, if approval is given, the notification may be sent electronically.

Real-time compliance monitoring is handled by the UMV Operations System condition-sensing station 16 network. The network may use the condition-sensing station 16 network interface to retrieve approved mission plans for reference; the network subsequently uses the interface to store details of any detected breach in the LDMS 12 database. The Compliance and Safety engine 72 retrieves records of compliance breaches that occur during a UMV operation for review. The condition-sensing station 16 network may have already made a decision and/or have taken an action in response to a breach which is recorded in the database; the engine 72 decides whether it is appropriate or if any further action is required. Decisions about possible actions may be made depending on the severity of the compliance breach. In one example, where a UAV had flown outside of an approved flight corridor for a short period of time, for example <10 min, and the condition-sensing station 16 network had issued a warning at that time, the Compliance and Safety engine 72 may decide that the infraction was minor and no further action is taken. In another example, where a UAV entered shared airspace without approval, the Compliance and Safety engine 72 may decide to issue a fine and pass the UAV owner's details to the appropriate authority, in addition to whatever action the condition-sensing station 16 network performed. In another example, where a UMV had flown without an approved mission plan, and had a history of repeated transgressions, the engine may decide to suspend the UMV owner's licenses and/or user account, in addition to whatever action the condition-sensing station 16 network performed. Additional actions decided on by the engine are recorded in the LDMS 12 database along, with the breach details.

The Compliance and Safety engine 72 allows users to access and view mission plans via the user interface; the Compliance and Safety engine 72 may be further configured to generate a report or a series of reports to clearly display the mission plan. The engine may be configured to provide different levels of access to the information for different users. The Compliance and Safety engine 72 queries the database 62 to retrieve the mission plan then passes the information to the user through the user interface; if the user requests a mission plan that they are unauthorised to access, an error message may be returned instead. The mission plans are marked with a status, for example:
approved,
pending, or
amendments required,
   that is clearly displayed when a user views that mission plan. In one example, a commercial UMV operator may access all the mission plans they have submitted in order to check their status. In another example, an air traffic controller/authority may be permitted to access all approved mission plans for that day. The Compliance and Safety engine 72 may be further configured to display compliance breach notices and details of the breach. In one example, a commercial UMV operator may be able to access details of a breach involving one of their UMVs in order to dispute the breach. In another example, an air traffic authority may be permitted to access details of a breach, to be used in legal proceedings between a user and an affected third party; in this example the breach may have been, for example, a collision. In another example, an insurer may be permitted to access details of all breaches to increase or decrease the premiums of affected users.

Analytics Engine

The UMV operations system 10 contains an Analytics engine 80 to calculate statistics using the data the UMV operations system 10 collects. The Analytics engine 80 uses all the data collected, including telemetry, user registration, UMV registration or mission plan registration, to determine trends or patterns or other insights related to the operation of UMVs and the UMV operations system 10. In one example, telemetry data may be used to determine the rate of in-flight faults, and their reasons. In another example user registration data may be used to determine popular license types which may be of interest to the regulator or training schools. In another example, UMV registration data may be used to determine popular UMV types and configurations which may be of interest to manufacturers.

The Analytics engine 80 queries the database to retrieve the data to be used: the database may be queried periodically to keep the analyses up-to-date. In one example, the Analytics engine 80 may access the database daily to retrieve any new information that was stored from that day. In another example, the Analytics engine 80 may access the data on a weekly basis. Due to the potential volume of data, the Analytics engine 80 may be configured with a schedule to access the data only at specific times to avoid putting excessive load on the database. In one example, the Analytics engine 80 may only access the data during the night when no, or limited, UMV operations are conducted. In another example, the Analytics engine 80 may access the data only during weekends. In another example, the schedule may be dynamic; in this example the Analytics engine 80 may access the data simply whenever there are relatively few people using the LDMS 12, i.e. the database is not under significant load.

The Analytics engine 80 may use the retrieved data to calculate statistics using a variety of methods. For example the engine may utilise regression analysis, including linear, multivariate or bayesian regression methods, survival/reliability analysis, time-series analysis or other statistical techniques to generate insights from the data. The Analytics engine 80 may combine the data collected from different sources to generate more advanced insights. In one example, the Analytics engine 80 may combine data from collected telemetry, manufacturer specifications from UMV accounts and mission plan data to infer total carbon emissions over time, over an area; in this example the data may further be used to infer other environmental impacts UMV usage has had.

The Analytics engine generates a report or a series of reports from the statistics it calculates, the Analytics engine 80 may be configured to produce data visualisations to aid in interpretation of the data. For example, data visualisations could be graphs or 3D models. The engine may generate these reports periodically. In one example the Analytics engine 80 may generate reports on a monthly basis to display month to month trends. In another example the Analytics engine 80 may generate reports at the end of the year to display annual trends. Reports may be provided to certain users through the user interface. In one example, insurers may be permitted to access reports regarding the estimated lifetimes of certain UMV types. In another example, governments may be permitted to access reports regarding a complete history of organisations, personnel, vehicles and missions in the commercial UMV industry in that governments' jurisdiction.

UMV Network System

The UMV network system 30 is a device that may be included on UMV systems to provide a simple method of monitoring, controlling and/or identifying individual UMVs. The UMV network system 30 gathers data regarding the health of the UMV including, but not limited to, temperature, voltage, position, and altitude. The UMV network system 30 may also gather data which may aid in collision avoidance and navigation to provide to the UMV avionics/navigation system. The UMV network system 30 may even be configured to be the UMV avionics system. The UMV network system 30 also carries unique identifiers for each UMV which are assigned pre mission by the UMV Operations System Lifecycle and Data Management System (LDMS 12) such that each UMV may be associated with an approved mission plan as well as traced to its original registered owner.

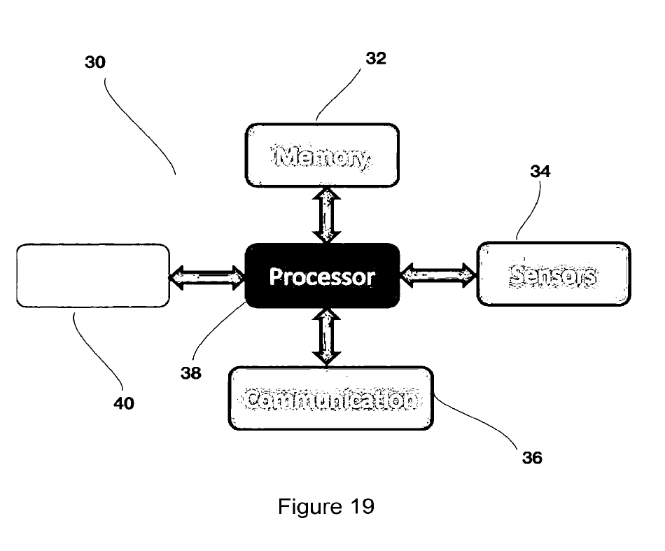

The UMV network system 30 is configured to provide the data it collects, partially or in its entirety, upon its interrogation by the UMV operations system 10 or a relevant air traffic authority; the UMV network system 30 may also provide this data periodically to the UMV operations system 10 during mission or the data may be collected in its entirety post mission. The data collected may then be used in a wide range of analyses by the UMV Operations System 10. The UMV network system 30 comprises an onboard computer processing system; a wireless communication system; a plurality of sensors for gathering data and a standardised external interface to allow integration into the UMV; an embodiment of these features is shown in FIG. 19.

Onboard Computer

The onboard computer system (OBC) of the UMV network system 30 provides computing services for the UMV network system 30. The OBC system comprises one or more processors 38 and memories 32 as shown in FIG. 19. The memory 32 may be split into operations memory and storage memory. The processor 38 may be, for example, a microprocessor, digital signal processor (DSP), field programmable gate <array (FPGA), application specific integrated circuit (ASIC), some other form of discrete logic circuitry, or any combination of these components. The operations memory may be volatile or non-volatile memory and is configured to store data such as intermediate results of algorithms or buffers for the communication system. The storage memory is non-volatile and is configured to store full telemetry packets. The storage memory may be accessed post-mission to allow analysis of the collected telemetry data.

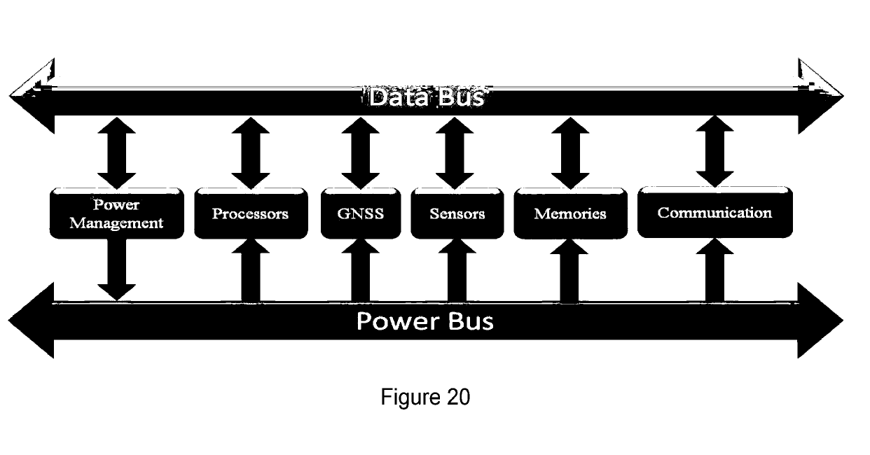

An OBC system with multiple processors and memories may be implemented as a distributed system as in FIG. 20 and connected together via a communication protocol, Communication protocols may include, for example, Ethernet, I2C, SPI, Spacewire, or other serial or parallel interchip communication protocols. The distributed computing architecture offers higher flexibility in being able to select suitable processors for each engine, depending on the computational requirements. In one example, high bandwidth wireless communication may require a high speed processor for encryption, encoding, modulation and other related processing; in this example a secondary high performance processor may be used to alleviate the load on the telemetry processor.

In another example, a processor 38 may be used in conjunction with a secondary processing element such as an FPGA. In this example the processor handles system control, telemetry and configuration functions, while the secondary processing element implements the computationally intensive data path, for example visual navigation algorithms, thereby minimizing the latency in the system. When it is necessary to switch from one algorithm to another, the processor can switch dynamically between major sections of software, while the FPGA can be completely reconfigured, as necessary, to implement the data path for a particular algorithm. In other examples the secondary (or tertiary etc.) processing element may be a DSP, ASIC or another microprocessor etc.; in these examples the secondary processing element is dedicated to one particular function, for example localisation, but may still provide low latency, high performance computing.

Each engine/processor may be configured to enter a sleep mode when it is not required. Engines in sleep mode may be woken up by other engines or by telecommand from the UMV operations system 10 as required. In one example, a processor handling path planning may be put to sleep to conserve power; in this example, the UAV network system 30 may rely on the UMV operations system 10 to provide path planning functions instead.

Sensors

The UMV network system 30 contains some set of sensors 34 to gather data regarding, the operation of the UMV. The sensors 34 may gather data for telemetry purposes and to aid the UMV navigation. There are two main types of telemetry data that will be collected by the UMV network system 30: environmental data, arid housekeeping data. The UMV network system 30 may feature more or less sensors 34 depending on desired functionality. In one example, a UMV manufacturer has developed complete avionics system and only needs the UMV network system 30 for interfacing with the UMV operations system 10, i.e. basic beacon telemetry. In one example the UMV network system 30 may only be configured with housekeeping sensors 33. In another example, a UMV manufacturer may only have developed a UMV structure and propulsion; in this example the UMV network system 30 may be configured with all environmental, housekeeping 33 and navigation sensors to provide the avionics and complete the UMV system.

The environmental data may include, for example, the temperature and pressure outside of the UMV. These sensors may be mounted on the UMV network system 30 form factor if it is exposed to the environment and connected directly to the OBC; in other examples, these sensors, may be mounted on the UMV frame outside of the UMV network system 30 and connected to the onboard computer through the external interface in FIG. 19.

The housekeeping data are used to monitor the health of the UMV. The housekeeping data may include, but is not limited to, geographical data (such as the UMV's position and velocity), inertial data such as the UMV's attitudes), temperature (inside) and electrical properties. All the housekeeping sensors may be contained within the UMV network system 30 form factor.

Data on onboard electrical properties may include, for example, internal power bus voltages and currents drawn from the external interface or power usage of individual systems such as the onboard computer or the communication system. These may be measured using current and voltage sensors.

The UMV's inertial data may be provided by inertial sensors. In one example, an inertial measurement unit (IMU) 35 is used which includes, for example, sensors such as accelerometers, gyroscopes, magnetometers etc. In another example, the attitude data may be provided by a differential GPS system, which uses the difference in signals from two separate GPS antennas placed along the longitudinal axis of the UMV 50 to calculate its attitude.

The UMV's position data may be an absolute position, i.e. with respect to a global inertial frame. The UMV's position data may be a relative condition i.e. with respect to a local inertial frame, perhaps centered on a condition-sensing station 16 of the UMV operations system 10. The UMV network system 30 may include both absolute and relative position data of the UMV 50 for greater functionality.

In one example, the global position may be estimated from a GNSS 31. However, in certain area the reception of GNSS signals is limited. For example in urban territories, satellite signals may endure multipath propagation where signals skip off structures, or are weakened by barometric conditions, dividers, or tree spread. In these examples, an assisted GPS (AGPS) system may use data available from mobile networks to determine the UMV's condition. GPS systems utilise mobile networks to provide additional data that may aid in positioning calculations such as existing but up-to-date orbital data. precise time or atmospheric conditions as well as accurate, surveyed positions of nearby mobile towers. In another example, where the UMV network system 30 is connected to the local mobile network, multilateration based on received signal strength indicators (RSSI) of nearby mobile towers may be used to augment the position data further; muitilateration may be able to provide both global position data, by way of accurate, surveyed mobile tower positions, and relative position data for immediate or local use.

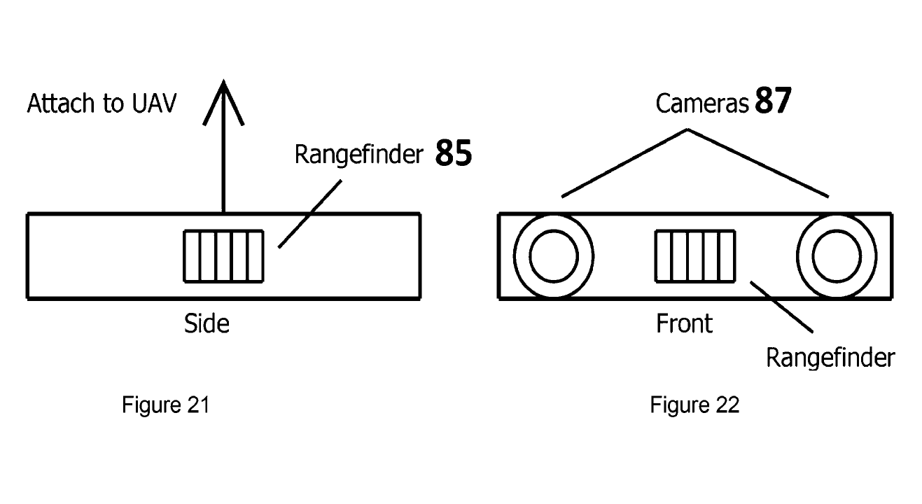

Relative position signals may be needed to, for example, help avoid collisions, localisation, for precise landings or other navigation purposes. When GPS signals are not available, the UMV network system 30 may use sensors, including, for example, cameras 87, inertial sensors and rangefinders together with priori knowledge to estimate the UMV's global positions and relative positions. Navigation sensors are necessary for this purpose. In some examples, a vision based system containing one or more cameras may be used to determine the UMV's position in the area; in this example, the data from the vision based or electromagnetic based system may also be used for navigation purposes in combination with the rangefinding system 85. In other examples, rangefinders 85 may be used to determine the distance to nearby objects and/or landmarks and infer the UMV's position in the area; in this example, rangefinder data may also be used for navigation purposes. Data from navigation sensors may be used with an algorithm to convert the data into relative position signals. Rangefinding and visual sensors are discussed further below and shown n FIGS. 21 and 22 and 25.

Rangefinding System

The UMV network system 30 may be configured with a rangefinder system 85 to determine the relative distances between the UMV and other objects. The rangefinder system 85 may be configured to use, for example, a Laser, Radar, ultrasonic rangefinder, other rangefinding systems or a combination of different rangefinders. The rangefinding system 85 is configured to scan its field of view and provides range and bearing data for processing.

The ultrasonic rangefinder systems use sound propagation through the air to determine distances. The active ultrasonic rangefinder generates a sound beam and listens for its reflections. The time of the transmission of the pulse to its reception is measured and converted to distance by knowing the speed of sound through air. Ultrasonic rangefinders may generate different beam angles with a narrow beam angle being better for detecting objects at long distances and a wide beam angle being better for detecting objects at, short distances.

Laser systems use visible or invisible directional laser beam to measure distances, Techniques for measuring distances include, for example, triangulation, time-of-flight measurements, interferometers, and phase shift methods. Laser beams are much more directional compared to other radio or sound waves, providing highly accurate measurements. To increase its field of view, the laser rangefinder may be configured with an optical reflector to change the beam direction, compensating for the extremely narrow beam pattern. In one example, optical reflector is mounted on a gimbal system to provide mechanical scanning.

Radar systems use electromagnetic waves, specifically radio waves, to measure distances. Techniques for measuring distances include, for example, time-of-flight measures, frequency modulation, and phased array methods. Radio waves travel at the speed of light for quick and accurate measurements. Radar allows detection at ranges where sound or visible light are weak. The Radar system may utilise phased arrays and/or digital beamforming to track objects within its range to avoid moving parts and increase its field of view.

Most of the rangefinders 85 have a limited field of view. Multiple rangefinders may be used to expand the field of view. In one example, a UMV may only need the rangefinding system for obstacle detection; in this example a single rangefinder pointing forward may be sufficient. In another example, a UMV 50 may want to use its rangefinding system 85 for terrain mapping; in this example, multiple rangefinders placed around the UMV network system 30 may be used. In some examples, where multiple rangefinders are used, the data may be combined to to estimate the altitude of the UMV 50. The UMVs may be configured to operate in different conditions, for example, low visibility and high air or sea turbulence. The UMV 50 may have multiple different rangefinders onboard to improve the accuracy of distance detection and for redundancy. In one example, where the UMV 50 is configured withi both an ultrasonic and radar rangefinder and is flying through areas of high turbulence, the radar rangefinder may compensate for the ultrasonic signals being blown away.

Vision-Based Navigation

The UMV network system 30 may be configured to contain one or more cameras 87 and/or electromagnetic sensors 87 which collect image data of the environment. The image data may be able to be used, for example, to map the environment, estimate relative motion of the UMV 50, identify objects in the field of view, or other navigation actions. The vision data may be obtained from, for example, standard definition (SD), high definition (HD), omnidirectional cameras, fisheye lens cameras, stereo cameras, other types of cameras or electromagnetic sensors or some combination of cameras or electromagnetic sensors.

The UMV network system 30 may utilise one or multiple cameras/sensors to estimate the UMV's motion. For example, multiple cameras/sensors can be mounted around the UMV network system 30 form factor to obtain a full field of view. Alternatively, a camera/sensor 87 can be mounted in a gimbal structure where the camera/sensor 87 can change its direction with a tilt and pan servo. In some examples, the UMV Network System may be configured with a single omnidirectional camera/sensor 87 to estimate the motion; in other examples the UMV network system 30 may use a combination of different cameras 87 for UMV navigation and guidance. For example, the UMV may use an omnidirectional camera/sensor 87 to estimate the attitude and a stereo camera/sensor to estimate the motion and altitude.

Wireless Communications

The UMV network system 30 will store the telemetry data in the non-volatile memories. These data will also be transmitted to the position-sensing station 16 upon interrogation or periodically via a wireless communication link 36. The communication mechanisms may include, for example, direct RF links, wireless networks or satellite links. However, not all the links may be available at the same time. In some examples, a mixture of communication mechanisms may be used to guarantee the continuous and secure link between the UMV 50 and the condition-sensing station 16. In one example, the UMV network system 30 may be configured with a UHF and a cellular, for example GSM, communication link.

The wireless communication system 36 may be implemented using an RF front end and a processor utilising software defined radio (SDR); this allows the communication system to have greater flexibility in being able to be configured for different frequency bands dynamically which can then be employed for communication. The SDR configuration may be part of the distributed system as above described. In one example, the SDR system may support a S-band configuration, for example 2.4 Ghz, and a UHF configuration, for example 900 Mhz; in this example the SDR system dynamically switches between software configurations depending the desired transmission. For example, the SDR system may use the UHF configuration for basic beacons and the S-band configuration for enhanced telemetry transfer.

The direct RF links may include any commercial radio frequencies, including, but not limited to, VHF, UHF, and S-band. Depending on the UMV 50 configuration and the required data rate, some of the RF frequencies may be more appropriate than others. For example, basic beacon packets may need only a low data rate. In this case. VHF or UHF is good with a proper modulation technique, for example frequency shift keying (FSK), phase shift keying (PSK) or other types of modulation. For image/video data, due to the large data size it is more proper to have a fast RF link, using higher frequency bands, for example S band or K band or other high frequency bands.

The communication link 36 between the UMV 50 and the condition-sensing stations 16 may be established upon a standard terrestrial wireless network, including fixed wireless networks, for example, Australia's NBN wireless network and WIFI hotspots; mobile networks may be also used, for example, the Global System for Mobile Communications (GSM) network, the Code Division Multiple Access (CDMA) network, an Enhanced Data for Global Evolution (EDGE) network, a Long Term Evolution (LTE) network or other types of mobile networks. In one example, the UMV network system 30 is configured with an industry GSM device, and SIM card, and supports data transfer over the local GSM network; in this example the condition-sensing station 16 is configured with a similar device and its own SIM card.

Satellite links enable the UMV 50 relay its telemetry data to the condition-sensing station via a communications satellite. The UMV 50 may connect directly to a constellation of either geostationary or low-earth-orbit satellites. Telemetry data are then transmitted to the condition-sensing station 16 directly or the data can be forwarded to the control centre through the satellite tele-port connected to, for example, the Public Switched Telephone Network. In one example, the UMV network system 30 may be configured with a satellite telephony device, for example the an Iridium device, which supports data transfer over the Iridium network.

For security purposes, the communication link may be configured to use a suitable encryption method, for example, a public-private key system. In one example, the onboard computer may be configured with a co-processor which is configured with a hardware AES-128 accelerator which encrypts data before it is sent to the communication link.

The UMV Network system may be further configured to create wireless communication links with one or more other UMVs, configured with a UMV Network system, which are in range. These wireless communication links may also he used to verify the presence of other nearby UMVs. In one example, where a nearby condition-sensing station 16 has developed a fault, the UMV Network system may act as a relay for other UMVs to pass data to a neighbouring condition-sensing station 16 that is functioning correctly. In another example, where an environmental alert needs to be disseminated quickly, the UMV Network system may be configured to create an ad-hoc network with other UMVs, bypassing the condition-sensing stations 16, to ensure potentially affected UMVs have enough time to respond.

Antenna

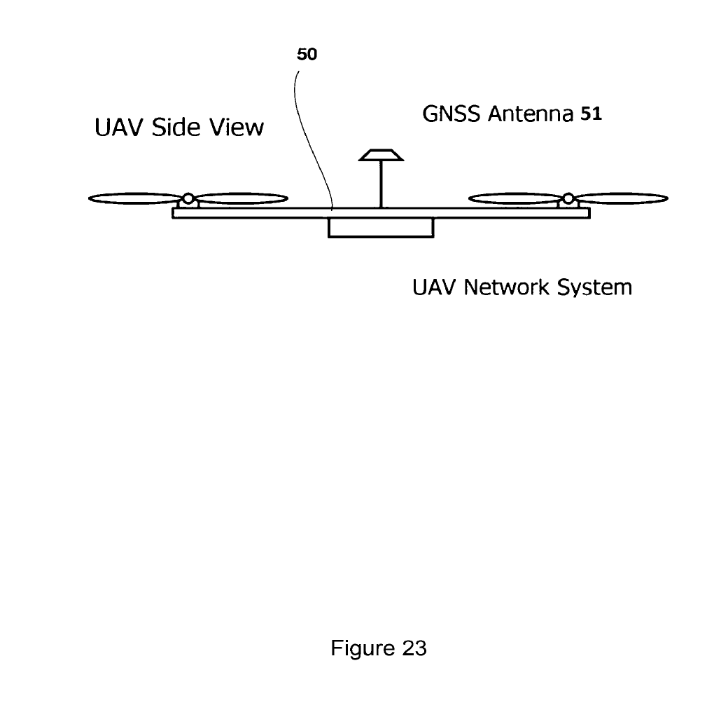

One or more antennae 51 will be necessary to receive GNSS signals; these are generally mounted on top of the UMV 50 to function correctly. The antennae will be able to receive signals from at least one GNSS: GPS, GLONASS, BeiDou-2 COMPASS or Galileo. The antennae 51 may be, for example, dipole, loop, microstrip or other antennae or a combination of these types of antenna. The antennae 51 may be attached directly to the UMV network system 30 as the UMV 50 form factor allows. For example, as per FIG. 23; in other examples the antennae may fed via transmission line from a mounting on top of the UMV to the UMV network system 30.

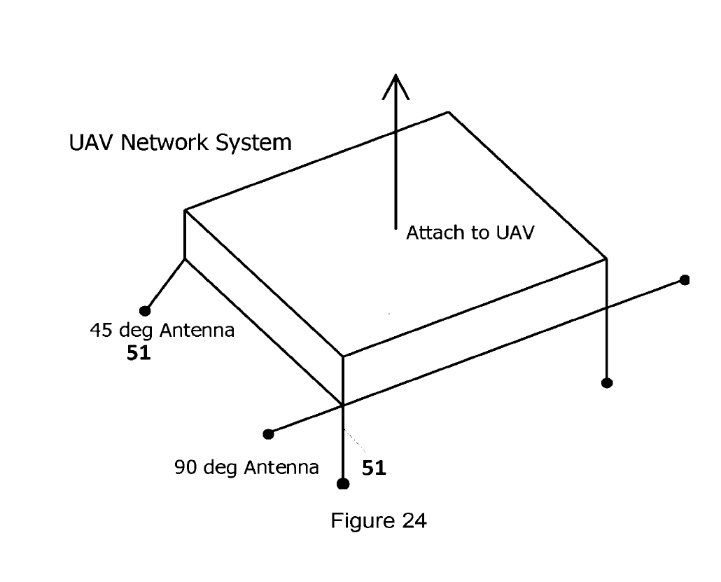

One or more antennae will be necessary to form a wireless communication link. These antennae may be tuned to different frequency bands, for example, VHF, UHF, S-band, cellular (e.g. GSM, LTE or others) bands or others. The antennae may be, for example, dipole, loop, microstrip or other antennae or a combination of these types of antenna. The antennae may be directly attached to the UMV network system 30 or may be fed via transmission line from a mounting on the body of the UMV to the UMV network system 30. Multiple antennae may be placed parallel, at 45 degrees or at 90 degrees to the UMV network system 30 baseline in order to receive signals of different polarisations. For example, as in FIG. 24.

Interface

All the sensors in the UMV network system 30 function independently from, and in addition to, the UMV avionics system. The external interface to the avionics system allows user to use the UMV network system 30 as part of its avionics system. The external interface connects the UMV network system 30 with the UMVs avionics and contains at least a power interface and a communications interface; in some examples, the external interface may contain additional sensor interfaces or an interface for a removable mass storage device.

The communication bus may be configured with a standard bus network communication protocol such as, for example, Ethernet, USB, I2C, SPI, SpaceVVire, All the engines may be interconnected through a bus network architecture using a controller; the UMV network system 30 will act as a bus master. The power interface contains pins to connect to the UMVs power rails which will supply the desired voltage to the UMV network system 30; for example, 3.3 V, 5 V, 12 V, or other voltages.

In examples where sensors must be placed away from the UMV network system 30 form factor, for example, a pressure sensor mounted on the outside of the UMV frame, the sensor connects to the UMV network system 30 using the same communication bus. In some examples, where an antenna must be placed away from the UMV network system 30, for example a GLASS antenna mounted on the top of a UMV frame while the UMV network system 30 is mounted underneath, the external interface will include the appropriate connector for a transmission line to feed the antenna.

Telemetry

The UMV network system 30 will periodically collect telemetry data from sensors 34 during operation of the UMV. A basic beacon consisting of a subset of telemetry data will be transmitted to the UMV operations system 10 upon wireless interrogation from the UMV operations system 10. The UMV network system 30 may be configured to transmit the basic beacon periodically in addition to transmission upon interrogation from the UMV operations system 10. The basic beacon includes at least the following data;

Identification number(s) of the UMV 50 which may include the UMV account registration number (from the LDMS 12), a squawk code for air traffic operators or a flight number associated with a valid and approved flight plan or other forms of identification.

Altitude

Absolute position estimate

Error codes related to any detected faults with the UAV network system 30

The UMV network system 30 may be configured to transmit an enhanced telemetry packet upon interrogation from the UMV operations system 10; in some examples, the UMV network system 30 may he configured to transmit an enhanced telemetry packet to the UMV operations system 10 periodically. The enhanced telemetry packet includes the telemetry data included in the basic beacon as well as at least:

Temperature

Power bus voltages

Attitude estimate

Velocity estimate

The basic beacon telemetry data will be stored in non-volatile memory for the duration of the UMV mission, in some examples, the enhanced telemetry packet data will be stored in non-volatile memory for the duration of the UMV 50 mission. In some examples, enhanced telemetry packet data, but not basic beacon data, that has been received by the UMV Operation System may be selectively erased from memory during the operation of the UMV 50. Telemetry data that has not been transmit to the UMV Operation System or has not been erased from memory may be retrieved from memory via an external communication interface after the UMV mission plan has been completed; telemetry data downloaded in this way may then be uploaded to the UMV operations system 10 for review.

Software Design

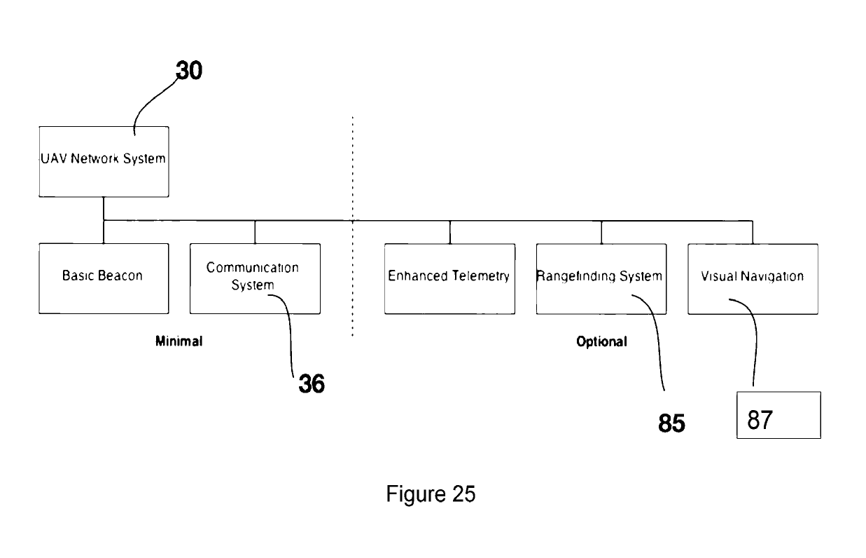

The UMV network system 30 may be configured to contain minimal functionality to work alongside existing UMV navigation/avionics systems; the UMV network system 30 may also be configured to provide optional enhanced functionality for example, by generating navigation actions. The UMV network system 30 may be configured to dynamically increase or decrease optional functionality via telecommand from the UMV operations system 10. The minimal and optional processes can be seen in FIG. 25.

In the minimal functionality configuration, the UMV network system 30 gathers relevant mission data/telemetry through a set of sensors and stores and/or transmit that data to the UMV operations system 10. The onboard computer may be configured to either partially process telemetry and/or sensor data on-board or directly store, it in the memory; the telemetry data may be transmitted to the UMV operations system 10 using the Communication System 36.

With the addition of the optional functionality, the UMV network system 30 may be configured to provide the full avionics system for the UMV, i.e. the software may be configured to run all the functions that are required to operate the UMV 50. In addition to the telemetry processing, the UMV network system 30 may run algorithms, which may include, but are not limited to, mission planning, flight path planning, power management, attitude control, actuator control or other algorithms. In one example, the UMV network system 30 may be configured to analyse range to objects data gathered in the surrounding environment and implement steps to avoid collisions with obstacles, in this example, the UMV network system 30 may be further configured to use this analysis to provide high-level navigation actions, for example, path planning. In some examples, where the UMV Network System is configured to work alongside the existing UMV avionics, the UMV Network system may be configured to communicate with the existing avionic system, for example through a serial connection, to provide navigation actions to the avionics or use data collected by the avionics to enhance the UMV network system's telemetry. In some examples, where the UMV Network system is configured to provide the full avionics of the UMV the UMV operations system 10 may be configured to forcefully take control of the UMV network system 30, and thus the UMV navigation/avionics, through, for example, telecommands, in response to compliance breaches or other unlawful behaviour.

The Basic Beacon engine 53 is configured to periodically sample the GNSS estimates for position and altitude data. In some examples, where a separate altitude sensor is included, the process samples the altitude sensor as well; in some examples, where both altitude estimates are available, the Basic Beacon engine 53 may be configured to favour data from one over the other to include into the Basic Beacon telemetry packet. In one example, where a GNSS altitude estimate is unavailable, the altitude sensor estimate is used regardless of how the Basic Beacon engine is configured. In the case where neither estimates are available, the Basic Beacon engine leaves the altitude field blank for the next telemetry transmission, but registers a fault. Similarly, if the GNSS position estimate is unavailable, the Basic Beacon engine 53 leaves the position field blank in the Basic Beacon telemetry packet and registers a fault. The Basic Beacon engine 53 stores in memory the UMV registration number, from the UMV account number in the LDMS 12. The Basic Beacon engine 53 will retrieve from memory the identification numbers from storage for transmission in the Basic Beacon telemetry packets. In addition to transmission, the Basic Beacon engine 53 records each telemetry packet in memory.

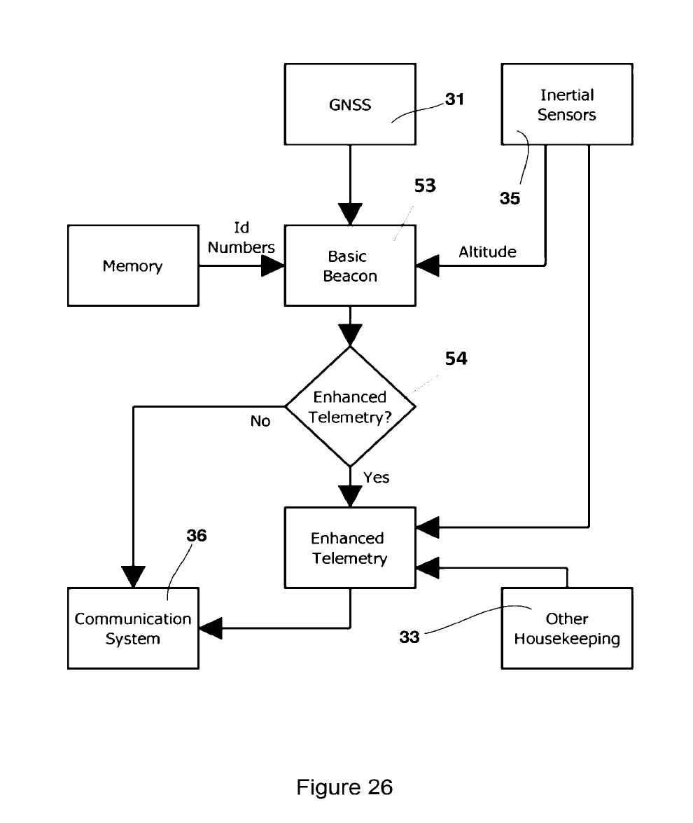

The Enhanced Telemetry engine 54 is shown in FIG. 26 and is configured to periodically sample a number of sensors which may include, for example, temperature sensors, current sensors, IMUs or other data. The Enhanced Telemetry engine 54 is configured to include each available sensor data as an additional field in an enhanced telemetry packet. In examples where the Enhanced Telemetry engine 54 is enabled, the engine takes Basic Beacon telemetry packets, appends to the additional fields and then transmits whole packet. In addition to transmission, the Enhanced Telemetry engine 54 is configured to record each telemetry packet in memory.

The Enhanced Telemetry engine 54 may be further configured to partially process telemetry data before transmission. In one example, inertial data gathered from, for example, an IMU, is processed to provide attitude (roll, pitch, yaw) estimates of the UMV 50. In another example, data gathered from an IMU may be sent to an estimation algorithm, for example a Kalman Filter, where it may be used to create a model of the UMV's attitude over time, predict possible future attitudes and correct for discrepancies between actual and predicted values to update the model; the model can then be used to provide the up-to-date attitude estimates as required. In another example, data gathered from the IMU may processed to provide position estimates that may be used in the event of GNSS failure. In some examples, where the IMU is configured to provide velocity data, this data can be integrated in a ‘dead reckoning’ process to estimate the current position; in other examples, the IMU and GNSS data may be provided to an estimation algorithm, for example a Kalman Filter, which combines the data to model the UMV 50's position and provide more accurate position estimates.

The Communication System engine 36 handles the wireless communication link for the UMV network system 30. The Communication System engine 36 nominally accepts complete Basic Beacon or Enhanced Telemetry packets into its buffers before transmitting the packet over the communication link. The Communication System engine 36 may be configured to request and wait for an acknowledgement of reception signal for packets from the UMV operations system 10; the Communication System engine 36 may be further configured to re-transmit the last packet a number of times if no acknowledgement signal is received. The Communication System 36 engine may be configured to interrupt any other processes in order to perform an action if a request is made by the UMV operations system 10 or a relevant air traffic authority; in one example, the UMV network system 30 may be gathering data, but the UMV operations system 10 may send a command for the UMV network system 30 to transmit an updated Basic Beacon packet or an Enhanced Telemetry packet; in this example, the engine may interrupt the data collection to transmit the a telemetry packet immediately.

The Rangefinder System engine 85 is configured to periodically scan the rangefinder's field of view and return range and bearing data. The engine may be configured to use the data to estimate the UMV's relative position to other objects. In some examples, a laser rangefinder may use time-of-flight, measurement to determine its distance from the obstacle; in other examples, with a 3D laser scanner, it may be possible to estimate the geometry/shape of the obstacle. In some examples, the distances between the UMV 50 and the obstacles may be directly sent to the UMV operations system 10 for analysis; in this example, navigation actions may be provided by the UMV operations system 10 after analysis. In other examples, the engine may be configured to use the range data to calculate a set of waypoints to avoid static or dynamic obstacles and then bring the UMV 50 back to its original mission path; in these examples deviations from the original mission plan may be reported to the UMV operations system 10. In a GPS denied area, the engine may be further configured to use the range data to localise the UMV 50. The engine may be further configured to use a sensor fusion algorithm to combine data from multiple sensors to provide a higher accuracy localisation estimate; other sensor data may include, for example, velocity, magnetic field readings, or other collected data.

The Visual Navigation engine is configured to capture images of the local area. The engine may use the data with algorithms to aid in navigation or it may be configured to transmit the data to the UMV operations system 10 as part of an Enhanced Telemetry packet. In some examples, image data may be sent to the UMV operations system 10 directly for further analysis; in these examples the Visual Navigation engine may be configured to preprocess the image data, for example, by encrypting or compressing the data.

The Visual Navigation engine 87 may be configured to use an algorithm to extract features and identify landmarks in the image data. Feature extraction may be provided by, for example, the SIFT algorithm. Features and landmarks are used in a variety of vision-based navigation algorithms to provide, for example, localisation, path planning, collision avoidance or other navigation actions. Features may be used to detect static or dynamic objects which may be a potential hazard or obstacle. The Visual Navigation engine may be configured to have prior knowledge of landmarks which may include, for example, buildings, trees, rivers, hills or other landmarks. In one example, these landmarks can be obtained from a land surveying authorities. In another example, the landmarks may be obtained by a commercial map providers, such as google maps; in this example the landmarks may be stored onboard, for example, as 3D city models.

In some examples, where prior knowledge of landmarks is known, extracted landmark features from collected image data may be compared to the priori knowledge maps to enhance the knowledge of local landmarks. In these examples, and other examples, the UMV 50 may be configured to use this image data to generate local waypoints in order to follow the original planned mission paths or authorised deviations. The Visual Navigation engine may be further configured to combine feature extraction and other image processing algorithms to determine the shape of obstacles in a local or global reference frame and subsequently use path planning algorithms to generate local waypoints to avoid obstacles. In these examples, deviations from the original mission plan may be reported to the UMV operations system 10.

The Visual Navigation engine 87 may be configured to use camera/sensor images to detect the horizon of the Earth, which may be used to determine the UMV 50 attitudes together with other sensors in an estimation algorithm. Similarly, the Visual Navigation engine may be configured to combine data from multiple sensors, for example the rangefinder system, using a sensor fusion algorithm, to provide more prudent navigation actions. The Visual Navigation engine may be further configured to utilise a Simultaneous Localisation and Mapping (SLAM) algorithm, which may allow the UMV 50 to estimate its position and build a map of local area when flying in unknown environments.

The Visual Navigation engine may be configured to have prior knowledge of the entire physical environment. In one example, the Visual Navigation engine is configured with a granular 3D map of the airspace surrounding the proposed mission path; in this example the granular 3D map may be enhanced with additional information, for example environmental data, allowing the Visual Navigation engine to make better navigation decisions (for example to avoid bad weather). In another example, the Visual Navigation engine is configured to represent the entire surrounding physical environment as a digital point cloud; in this example, relevant data, for example environmental data, may be attached to each point as an attribute and each point may be uniquely addressed for easy reference,

Failure Modes

The UMV network system 30 may be configured to handle faults independently or it may be configured to notify the UMV operations system 10 of faults developing,

In order to mitigate processor failure, the UMV network system 30 may be configured to include a redundant processor that at least maintains Basic Beacon functionality. The UMV network system 30 may be configured to store relevant identification numbers in read-only memory (ROM) or variants such as programmable ROM (PROM) to facilitate the redundant processor or to allow quick recovery from reset.

If the GNSS data is unavailable, the UMV network system 30 may be configured to notify the UMV operations system 10. If configured with inertial sensors and inertial data is available, the UMV network system 30 may be configured to utilise inertial data to estimate the UMV's position temporarily. If no position data is available at all, the UMV network system 30 may be configured to request the UMV's avionics reduce the UMV's velocity to the minimum necessary to maintain altitude. In some examples the UMV network system 30 may be configured to request relative position data from nearby UMV operations system 10 position-sensing station 16s in order to continue.

If the communication link fails or its security is compromised, the UMV network system 30 may be configured to store all telemetry data, regardless of configuration during nominal operation. The UMV network system 30 may be configured to revert back to the original stored mission plan, discarding any revisions or deviations made during nominal operation. The UMV network system 30 may be configured to request the UMV's navigation/avionics system reduce the UMV's velocity to the minimum necessary to maintain direction/altitude due to the lack of data from the UMV operations system 10 about potential obstacles. If the UMV network system 30 has been configured as a distributed system, the onboard computer may be configured to reset the communications system and rescan relevant frequencies in an attempt to reestablish the communications link.

If the rangefinder fails, the UMV network system 30 may still be able to estimate its distances between other static objects using its position signals from GPS. The UMV operations system 10 will be notified of the UMV's situation from the telemetry data;in this example the UMV network system 30 may be configured to acquire other nearby UMVs' global positions from the UMV operations system 10. The distance between the UMV and buildings may be calculated by the UMV's global position and the building's global position, which may be obtained from the on-board stored maps or the UMV operations system 10, The UMV network system 30 may be further configured to request the relative position of the UMV from the UMV operations system 10. In this example the distances between the UMV and other static or dynamic objects may be directed obtained from the UMV operations system 10. The UMV network system 30 may be configured to request the UMV's navigation/avionics system reduce the UMV's velocity to the minimum necessary to maintain altitude pending a decision from the UMV operations system 10.

If the camera/sensors fails, the UMV network system 30 may still be able to control its mission path using its relative positions, estimated from the rangefinding system. In examples where the vision/electromagnetic-based navigation system includes a combination of sensors for navigation purposes, the mission path planning algorithm may be configured to generate waypoints without the image data, however suboptimal. In some examples, the UMV network system 30 may be configured to request the UMV operations system 10 to help generate local waypoints; in other examples, the UMV network system 30 may be configured to simply fall back on the waypoints associated with the original mission plan. The UMV network system 30 may be configured to request the UMV's navigation/avionics system reduce the UMV's velocity to the minimum necessary to maintain direction/altitude pending further information from the UMV operations system 10.

Hardware—Operations System 10

The UMV operations system 10 contains a distributed network of condition-sensing stations 16 that identify, track, interrogate and collect data from UMVs fitted with the UMV network system 30 es well as a control centre and a central database or repository for the collected data where the data may be stored and analysed. The UMV operations system 10 uses the data it collects to ensure compliance from UMV operators with regulations and approved, mission plans; the UMV operations system 10 may further use the data it collects in analysis which may include, for example, trends in UMV usage, rate of mechanical faults, the number of compliance breaches. or other insights. The UMV operations system 10 may provide this information to interested parties which may include, for example, air traffic authorities, insurers, UMV manufactures, or other interested parties.

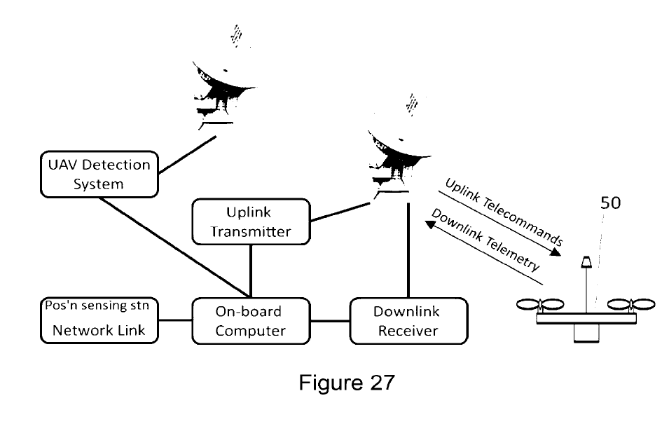

Each UMV operations system Condition-sensing Station (PS), as shown in FIG. 27, contains an onboard computing system, a communication system and a UMV detection system. The UMV detection system may be suitable detection systems including passive radar, doppler radar, continuous' ave radar, UWB radar. volumetric Radar, other radar and other forms of detection including optical.

The UMV Operations System condition-sensing station 16 network may be homogeneous where each individual condition-sensing station 16 has the same configurations, or may be heterogeneous where each individual condition-sensing station 16 contains different capabilities based on location or network needs. In some examples the UMV Operations System condition-sensing station 16 may be placed on top of utility poles used for the telephone network. In other examples, condition-sensing station 16 nodes may be placed on top of street-lights or traffic lights. In other examples, condition-sensing station 16 nodes may be placed on top of tall buildings such as apartment or office buildings; in other examples the condition-sensing station 16 may be a standalone structure.

The UMV Operations System Control Centre (CC) has a similar configuration as the condition sensing station but has expanded software functionality to consolidate telemetry data collected by the condition sensing station network and provide control actions for the condition sensing station network. For example, the control centre 14 may be configured with a real-time tracking engine and compliance system to ensure UMVs within the condition sensing station network are abiding by relevant laws and regulations. In another example, the control centre 14 may be configured to perform real-time analysis of telemetry to provide insights that may be acted upon. For example, the control centre 14 may analyse telemetry data to determine unusual weather patterns and issue a warning to affected users in response. In another example, the control centre 14 may be able to use collected telemetry to calculate and provide supplementary navigation data to UMVs within the condition sensing station network.

Condition-Sensing Station (Condition Sensing Station16)

Onboard Computer

The onboard computer system (OBC) provides computing services for the condition sensing station 16. The OBC system consists of one or more processors and memories. The processors may be, for example, a microprocessor, digital signal processor (DSP), field programmable gate array (FPGA), application specific integrated circuit (ASIC), some other form of discrete logic circuitry or a combination of these components. The memories may be volatile or nonvolatile memory. Memories may be used to temporarily stored data, for example, telemetry or intermediate results of an algorithm. An OBC system with multiple processors and memories may be implemented as a distributed system connected together via a communication protocol. Communication protocols may include, for example, Ethernet. DART, I2C, CAN, SPI, PCI, USB, SpaceWire, or other serial or parallel interchip communication protocols. In one example, each software engine may be run on its own processor which are then connected together by a PCI bus.

Communication

The communication system for each condition-sensing station 16 contains two parts: a communication Fink with the UMV network system 30 and a communication link with nearby condition sensing stations and/or the control centre 14. The communication link with the UMV network system 30 is a wireless link. The communication link between a condition sensing station 16 and/or the control centre 14 may be a wireless or a wired link. The communication system (one or both links, in examples where wireless technologies are used) may be implemented using an RF front end and a processor utilising software defined radio (SDR); this allows the communication system to have greater flexibility in being able to, be configured for different frequency bands dynamically which can then be employed for communication. The SDR configuration may be part of the distributed system as described in Section 1.1. In one example, the SDR system may support two S-band configurations, for example 2.4 Ghz and 5.0 Ghz, and one UHF configuration, for example 900 Mhz; in this example the SDR system dynamically switches between software configurations depending on the capabilities of an in-range UMV.

Wireless communication links between the condition sensing station 16 and UMV network system 30 may include, for example, direct RF links, wireless networks or satellite links. The condition sensing station 16 contains both an uplink to send data, and in some examples commands, to the UMV network system 30 and a downlink to receive telemetry data from the UMV network system 30.

The direct RF links may include any commercial radio frequencies, including, but not limited to, VHF, UHF, S-band and K-band, depending on the UAV application and the required data rate. The condition sensing station 16 may support multiple frequencies to avoid congestion. In one example, the PS may support basic beacon transmission on a UHF frequency, for example, 430 MHz; in this example the PS may be configured to support other data transfer on a S-band frequency, for example 5.0 Ghz.

The communication link between the UMV and the PS may be established upon a standard terrestrial wireless network, including fixed wireless networks, for example, Australia's NBN wireless network and WIFI hotspots; mobile networks may be also used, for example, the Global System for Mobile Communications (GSM) network, the Code Division Multiple Access (CDMA) network, an Enhanced Data for Global Evolution (EDGE) network, a Long Term Evolution (LTE) network or other types of mobile networks. In one example, the condition sensing station 16 is configured with an industry GSM device, and SIM card, and supports data transfer over the local GSM network; in this example the UMV network system 30 is configured with a similar device and its own SIM card,

Satellite links enable the UMV 50 to relay its telemetry data to the base station via a communications satellite. The UMV may connect directly to a constellation of either geostationary or low-earth-orbit satellites. Telemetry data are then transmitted to the condition-sensing station 16 directly or the data can be forwarded to the control centre through the satellite tele-port connected to, for example, the Public Switched Telephone Network. In one example, the condition sensing station 16 may be configured with a satellite telephony device, for example the an Iridium device, to which supports data transfer over the Iridium network.

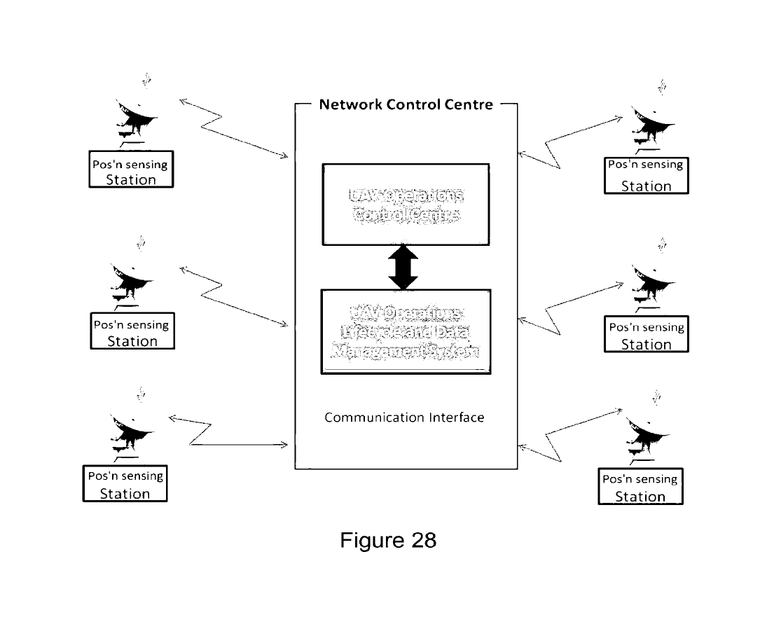

The communication link between each condition sensing station 16 which form the Condition-sensing Station Network, as shown in FIG. 28, may utilise existing mobile infrastructure such as GSM, 3G, LTE, CDMA or others, the condition-sensing station 16 may also be configured to connect to the control centre 14 directly via mobile technologies. In one example, each condition-sensing station 16 and the control centre 14 are configured with unique industry GSM devices, and SIM cards, which allows telemetry transfer over the local GSM network.

The condition sensing station 16 may be disposed on the ground. The condition sensing station 16 may be configured to connect to the internet and form a virtual condition-sensing station 16 network with others of the condition-sensing stations 16. In one example, each condition sensing station 16 may have a unique IP address and use Internet communication protocols, for example FTP, to support telemetry transfer.

The condition sensing station 16 may be configured with an additional wireless communication link such as Wifi (802.11 specification sets), VHF/UHF or others, and form a private ad hoc wireless network with the other condition-sensing stations 16. In one example, a plurality of the condition sensing stations 16 may form a wireless mesh network. In another example, the condition-sensing stations 16 may be configured with a satellite communication link, for example the iridium network, to communicate directly with the control centre 14 instead of passing data through other nearby condition-sensing stations 16.

For security purposes, data traffic on one or more communication links may use suitable encryption software, for example, a public-private key system. Similarly, data flow from the Condition Sensing System to the Control Centre will be encrypted where it will be stored using suitable enterprise-grade security software.

UMV Detection System

The UMV detection system contains sensors which are configured to observe the environment/airspace in some area around the condition-sensing station 16. In one example, the UMV detection system observes a 120° arc in front of the condition-sensing station 16 with a maximum range of 5 km; in other examples, the UMV detection system observes the full 360° around the condition-sensing station 16 with a maximum range of 2 km. The UMV detection system uses these sensors to detect any and all UMVs that enter its operational range.

The UMV detection system may contain rangefinder sensors, for example, radar, LIDAR, ultrasonic sensors, or other rangefinder sensors. The UMV detection system may further contain visual sensors, for example, high resolution cameras, hyperspectral imagers, 3D cameras or other visual sensors. The UMV detecton system may be configured to contain one or more different types of sensors to observe its operational area. In one example, the UMV detection system is configured with a single rangefinder sensor only, for example radar in another example the UMV detection system is configured with two rangefinder sensors working together, for example a radar for coarse-grained scanning of the operational area and a LIDAR for fine-grained scanning of the operational area. In other examples, the UMV detection system is configured with a rangefinder sensor, for example radar, as well as visual sensors, for example an omnidirectional camera, that work together to provide greater accuracy in detecting UMVs within the operational area. In other examples, the UMV detection system may be further configured with multiple rangefinder sensors as well as multiple visual sensors, or other sensors, all working together to form a multimodal sensing system for even greater detection accuracy.

### Radar System 45 (Embodiments Shown in FIGS. 26 to 37)

A radar system 45 may be provided in the embodiments show, as one embodiment of the UMV detection system, being configured so that each condition-sensing station 16 in the UMV Operations System may monitor the distance/airspace around it for UMVs. In order to reduce maintenance costs and to miniaturise the form factor, it is desirable that the radar system may have no moving parts. Instead the radar system may utilise phased arrays and/or digital beamforming to track objects within its range.

Radar is a known technology used for object detection within an area. In examples where the UMV detection system contains only one rangefinder, a radar system may be suitable. In other examples, where multiple sensors are used in conjunction with each other, the radar system may be configured as the primary sensor with other sensors acting as support. A multitude of radar technologies and techniques are potentially useful. For example, the radar system could be configured to produce simple time-of-flight measurements to a target. Other examples may make use of Doppler radar, passive radar, continuous wave radar, UWB radar, volumetric radar techniques or other radar technologies.

Phased arrays 47 are a series of radiating elements arranged in a pattern. These radiating elements may be, for example, ordinary dipole, microstrip, slotted, slotted waveguide, horn, solid state antennae or any other type of antenna. Successive radiating elements either radiate a phase shifted signal with respect to the previous element, or are triggered after a short time delay with respect to the previous element. Constructive and destructive interference between signals from successive radiating elements produces an overall radiating beam pattern that may be narrow and directional; altering the phase shift or time delay between successive elements alters the direction of maximum radiating power. With careful control over the phase shifts or time delays, the radiating beam may be steered as desired. The phased array may radiate at, for example, HF, VHF, UHF, L-band, S-band, C-band, X-band frequencies or other radio frequencies.

Selecting an optimal pattern for the phased array to ensure proper coverage depends on the details of different locations and environments. More complex patterns may provide better coverage of an area but at the cost of increased computational and power requirements; simpler patterns may be sufficient for certain areas, Patterns for individual condition-sensing stations 16 may be affected by the distribution of condition-sensing stations nodes throughout the area; in some examples, the radar system design may be heterogeneous throughout the UMV Operations System condition-sensing station 16 network.

One example of a phased array is a planar phased array. The antennae, are arranged in a grid-like structure upon a rectangular plane. In some examples the planar phased array may scan in the azimuth direction only; in other examples the planar phased array may scan in both azimuth and elevation. The planar phased array may cover an area in front of the array, but have limited or no coverage towards the sides, i.e. a limited azimuthal range; the planar phased array has similar limitations at the top and bottom edges i.e. a limited elevation range.

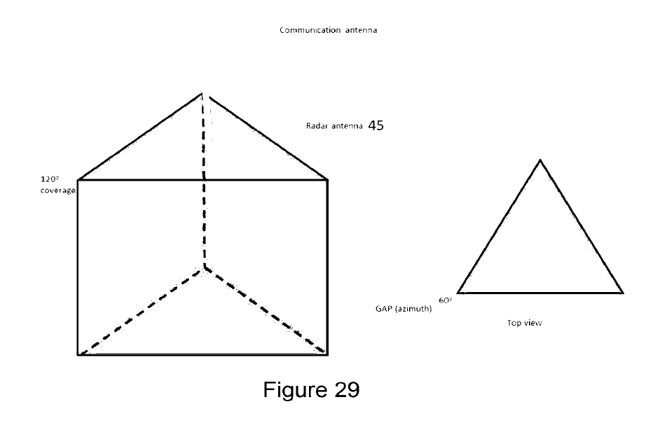

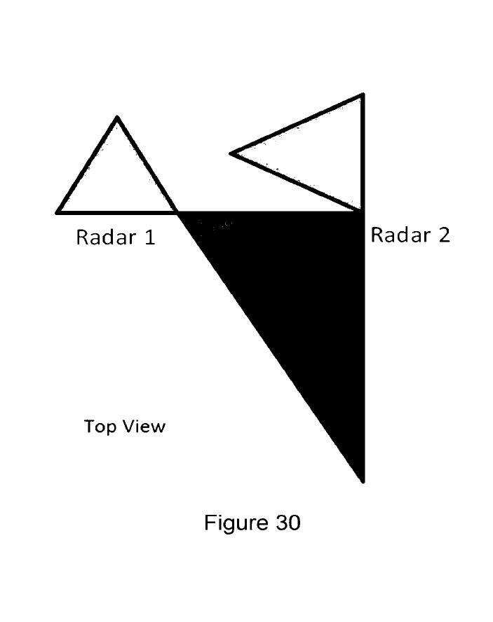

In order to provide greater coverage in an area, several planar phased array may be place together. In one example, three planar phased arrays may be placed in a triangular fashion, see FIG. 29. In this example, the radar system is able to provide modest coverage but still has gaps near the vertices of the triangular structure as well as directly above the radar system. In this example, condition-sensing station 16 nodes may be placed relatively close to one another and oriented such that neighbouring condition-sensing stations cover the gaps in each other's coverage, see FIG. 30. The area 99 is the deadzone for radar 1, which is covered by the second radar system; in some examples, the planar phased array may be tilted at, an angle to the horizontal rather than perpendicular to the horizontal in order to increase elevation coverage.

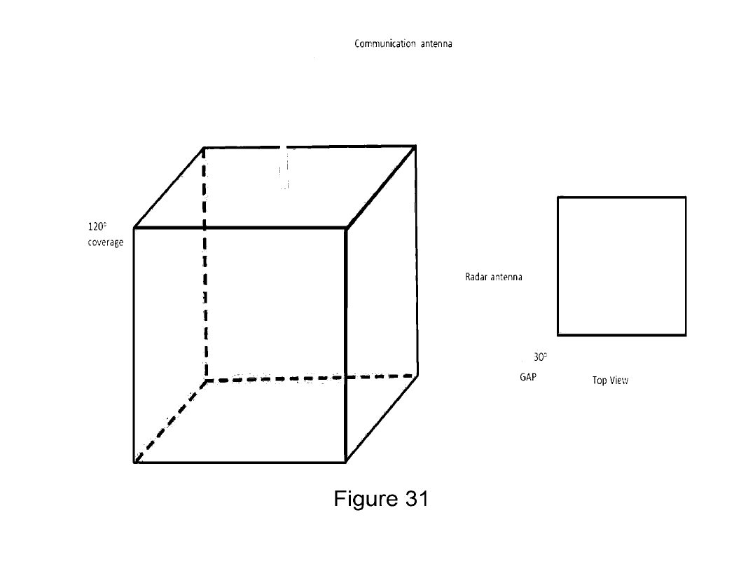

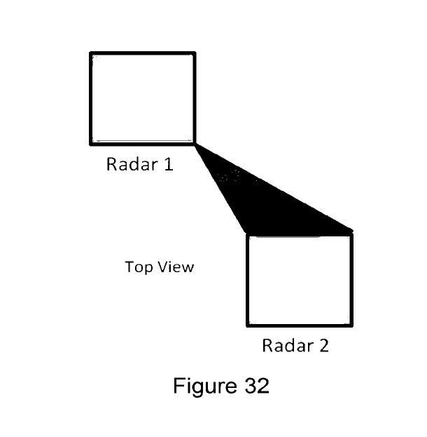

In another example, four planar phased arrays may be placed in a square or rectangular fashion, see FIG. 31. In this example, radar coverage is increased at the expense of greater complexity, however gaps in coverage still exist near the vertices of the square structure and directly above the radar system. In this example, nearby condition-sensing station 16 nodes may be placed and oriented to minimise the gaps in the overall coverage, see FIG. 32. The orange area is the deadzone for radar 1, which is covered by the second radar system; in some examples, the planar phased array may be tilted at an angle to the horizontal rather than perpendicular to the horizontal in order to increase elevation coverage.

Another configuration of a phased array is a conformal phased array. A conformal phased array is a phased array that conforms to a particular, complex shape. Conformal phased arrays required much more processing power than planar phased arrays and are much more difficult to manufacture, however benefit from greater coverage. Conformal phased arrays are capable of scanning in both azimuth and elevation. Conformal phased arrays still have limited ranges though the limitations are fewer than planar phased arrays.

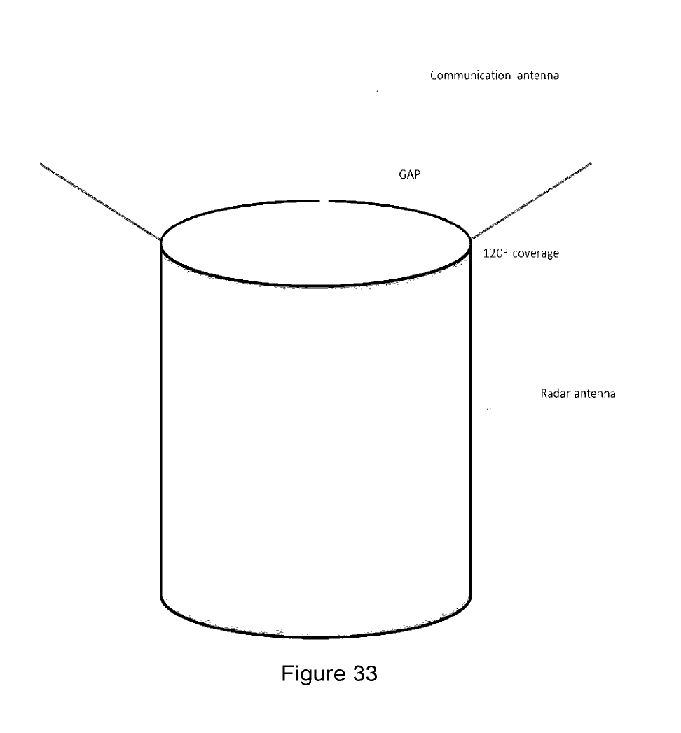

In one example, antenna are placed in rings around cylinder to form a cylindrical conformal phased array, see FIG. 33. In this example, the radar system is capable of scanning in the full 360° azimuthal range, however a gap in coverage directly above the radar system still exists. In this example, nearby condition-sensing station 16 nodes may be placed and oriented to minimise the gaps in overall coverage.

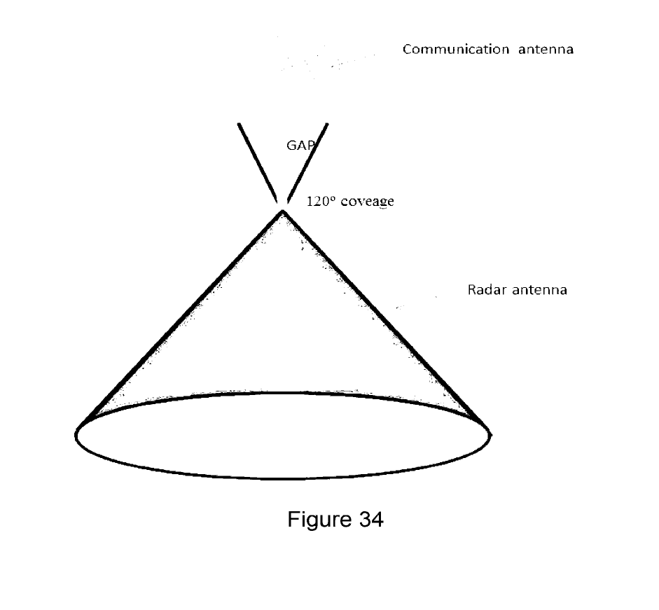

In another example, antennae may be placed in rings of decreasing diameter to form a conical conformal phased array, see FIG. 34. In this example, the radar system is capable of scanning in the full 360° azimuthal range and has a minimal gap in elevation range. In this example, nearby condition-sensing station 16 nodes may be placed or oriented to minimise the gaps in overall coverage.

The physical distribution of the condition-sensing stations 16 in the condition-sensing station network may be configured in a variety of ways depending on local conditions, for example terrain or urban density. The physical distribution of the condition-sensing station network also affects the configuration of the radar system. In one example, where the condition-sensing station network covers a high density urban environment, each condition-sensing station may be placed close together, for example <500 m due to blockages or reflections caused by buildings; in this example the radar system may be configured with higher frequency bands, for example 10 GHz X-band, with a modest transmit power, for example 10 W, which is sufficient to cover the short distances in between condition-sensing stations.

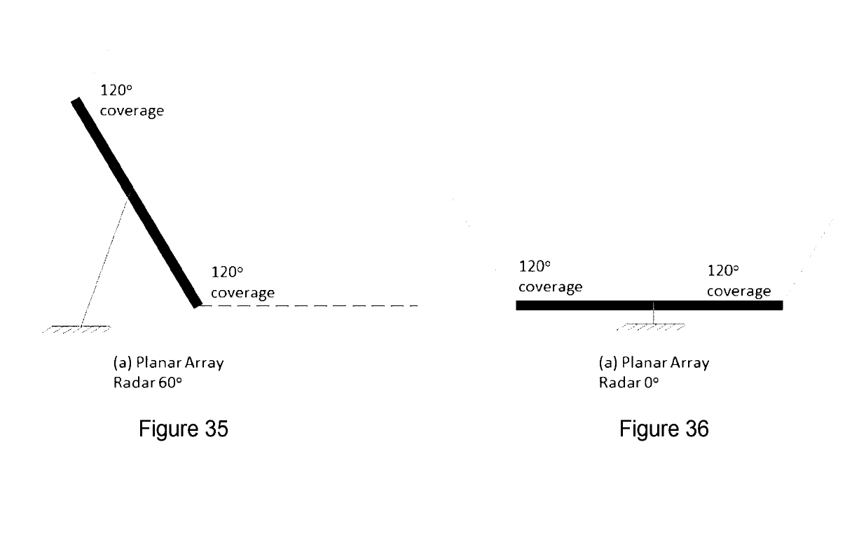

Condition-sensing stations 16 may need to be closer together to compensate for gaps in an individual PS's coverage. In one example, FIGS. 35 and 36 show an example of a possible configuration of two simple planar array radar systems. One radar system is placed with 60° inclination and the other one horizontally. Each radar system has a 120° coverage. The horizontal radar has two dead-zones below the dash lines. In this configuration, the left dead-zone may be fully covered by the inclined radar system. And the right dead-zone may be covered with another inclined radar system. The separation of the radar systems is proportional to the transmission power. In one example, where the radar system is configured with transmission power of 10 W and uses a L-band frequency of 1 Ghz, the condition-sensing stations must be placed no more than 1 km apart to ensure overlapping coverage.

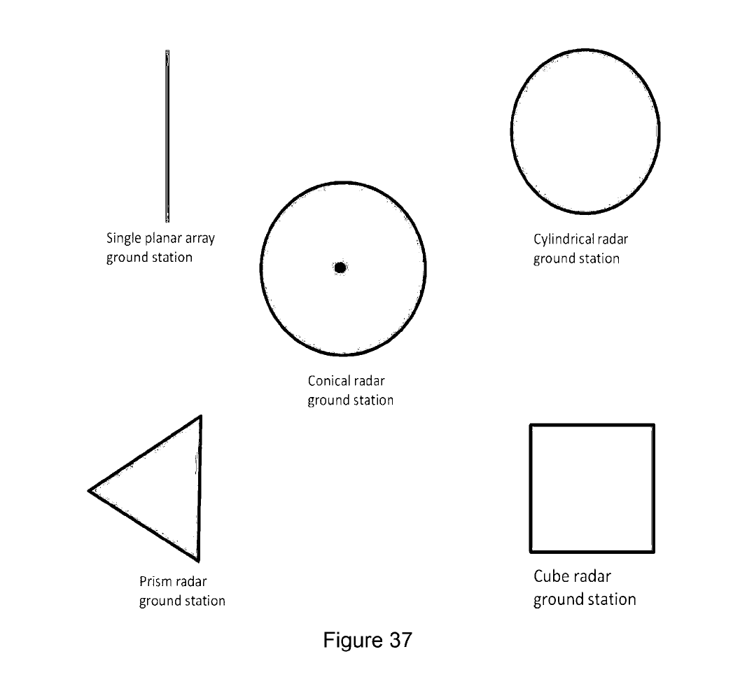

Different configurations of the radar system required different separation distances between each individual condition sensing station from other condition sensing stations to provide a full coverage of a flight corridor. Homogeneous radar system design may be preferred for low cost and simplicity. In one example, where the urban environment is low density, the terrain is flat and the airspace is mostly clear, repeating planar arrays may be the most appropriate configuration. In another example, where the terrain has many counters and the urban density is not uniform, a heterogenous condition sensing station configuration, for example FIG. 37, may be more appropriate. In this example, to avoid interference, each condition sensing station may use a different radar frequency and transmit power. For example, the conical array may be placed in a valley and so use a 10 GHz X-band transmitter at 10 kW for a 10 km coverage around the condition sensing station to cover the entire valley. The outlying condition sensing stations may then use 1 GHz L-band transmitter at 100 W for for a further 10 km coverage at the higher altitudes.

Other Rangefinder Systems

The UMV detection system may be configured to use a Radar system as the main sensor to detect UMVs in open airspace, above the urban environment. In one example however, small UMVs may be allowed to fly within an urban environment, in between tall buildings, by the air traffic authority, which may be below the Radar system's effective range and where radar signals suffer degradation due to multipath effects. In this example, and other similar examples, the UMV detection system may be configured with alternative rangefinders, for example ultrasonic or laser rangefinders, to either replace or supplement the radar system. The alternative configuration for the UMV Operations System condition-sensing station 16 may include with additional sensors, for example, cameras/sensors and rangefinders, to detect the UMVs and/or dynamic obstacles.

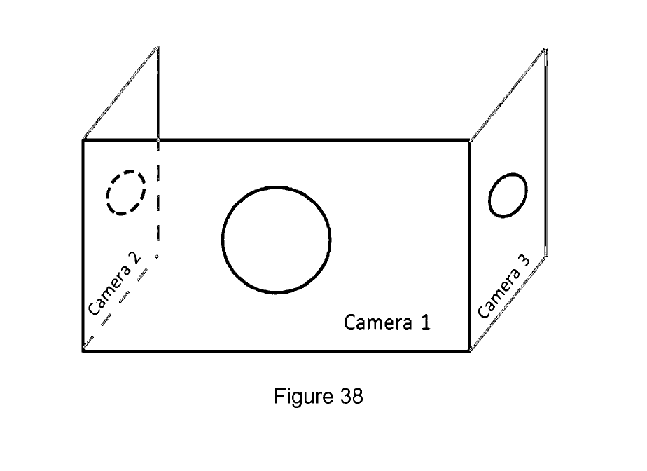

The UMV detection system may be configured with one or more visual sensors, for example, cameras, which collect visual data of the environment. The visual data may be obtained from, for example, standard definition (SD), high definition (HD), omnidirectional cameras, fisheye lens cameras, stereo cameras, infrared cameras, hyperspectral sensors, 3D cameras or other types of cameras or some combination of cameras/visual sensors. In some examples, the UMV detection system may be configured with cameras, for example stereo cameras, that have a wide field of view (for example, up to 140°). In other examples, the UMV detection system may be configured to use two or three cameras (as shown in FIG. 38) to have full coverage along the buildings. In similar examples, the camera may be mounted on a gimbal structure allowing the UMV detection system to rotate the camera to scan the operational area. In other examples, where it is necessary to detect, an object at a long distance (for example, >10 km), the UMV detection system may be further configured with a telescope or appropriate lens system.

The UMV detection system may be configured to use the visual data with image processing algorithms to detect objects within the operational range. In one example, where detection of only the presence of one or more UMV in the area is necessary, the UMV detection system may be configured with visual sensors only. In other examples, where detection of a UMV's location is necessary, the UMV detection system may be configured to use visual data as a coarse-grained scan of the operational area, and use an additional rangefinder system, for example radar, to determine the precise location of the UMV.

The condition-sensing station 16 may be configured to contain rangefinders, for examples ultrasonic, laser, or other types of rangefinders, which may be configured to detect the UAVs and obstacles in between the buildings.

Laser rangefinder systems use visible or invisible directional laser beam to measure distance and bearing town object. Techniques for measuring distance and/or bearing include, for example, triangulation, time-of-flight measurements,interferometry, and phase shift methods. In one example, where the condition-sensing station 16 is located within a dense urban environment, the UMV detection system is configured with a laser system only, which detects UMVs or other dynamic obstacles in between the buildings. In another example, where the condition-sensing system 16 is mounted on the top of a building, the UMV detection system may be configured with a radar system to observe the airspace above the building, and a laser system to observe the space between a neighbouring building and/or the street below Laser rangefinders have very narrow beamwidth, to increase the field of view an optical reflector may be used to change the beam direction. In one example, the reflector is mounted on mechanical scanner. In another example, a solid state laser scanner may be used, with fewer moving parts, which may reduce the maintenance costs.

Ultrasonic rangefinder systems use the propagation of high frequency sound waves to determine distance and bearing to an object. The passive ultrasonic rangefinder listens for ambient sound sources as well as reflections of these sources off of objects; characterisation of reflection paths may lead to object detection. The active ultrasonic rangefinder generates a sound beam and listens for its reflections. The ultrasonic system may be configured to generate different beam angles depending on the location of the condition-sensing station. In one example, where the UMV detection system is configured with an ultrasonic system only, the ultrasonic system is configured with a narrow beam angle (for example. <10°), which may be better for detecting objects at long distances. In another example, where the UMV detection system is configured with a radar system with an ultrasonic system in support, ultrasonic system may be configured with a wide beam angle (for example, up to 140°), which may be better for detecting objects at short distances, while the radar system handles long distance object detection.

In some examples, the UMV Operations System condition-sensing station 16 may be configured with multiple rangefinders, for example both laser and ultrasonic rangefinders, to have a full coverage along the buildings. In some examples, the condition-sensing station 16 may contain both the radar and extension system to provide substantially complete coverage of an area.

Control Centre (CC)

The Control Centre has the same onboard computer and communication system configuration as the condition sensing station 16, described above, but may not be configured with a UMV Detection System. In some examples, the control centre 14 may be configured with a UMV Detection System as described above; in these examples, the control centre 14 provides condition sensing station 16 functionality in addition to the expanded control centre 14 functionality. In other examples, the control centre 14 may be configured without a UMV Detection System; in these examples the control centre 14 only provides telemetry consolidation and control services to the condition sensing station network. The control centre 14 controls the condition sensing station network which has a network topology. In one example, the condition sensing station 16 network may be a mesh network. In another example, the condition sensing station 16 network may be configured as a star network. In these examples network topology may be realised by the condition sensing station 16 communication link.

The control centre 14 additionally contains an interface to the UMV Operations System Lifecycle and Data Management System (LDMS 12). The interface between the control centre 14, and therefore the condition-sensing station 16 network, and the LDMS 12 may be physical or logical. In some examples, where the control centre 14 and LDMS 12 share the same facility, the interface may simply be a software interface that allows the control centre 14 to deposit data in the LDMS 12 database, in other examples, where the control centre 14 and LDMS 12 are in different facilities, the interface may be a physical communication link, for example, over the internet.

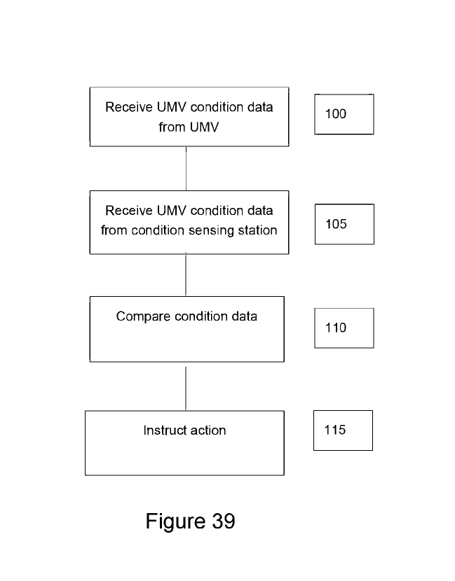

For the avoidance of doubt, in operation the system can be seen in one embodiment to function as shown in FIG. 39. That is, at step 100 a computer system receives UMV condition data, which can include position data, from one or more of a plurality of sensors on a UMV, potentially via a ground station or by some intermediary processing and network system, or otherwise directly. Then, at step 105, a computer system receives UMV condition data, which can include position data, or other data, including temperature, from a condition sensing station 16, and then the computer, at step 110, compares the data streams, separating the data from each sensor to compare each one on a like for like basis. Then, depending on the result of the comparison, and the level of some threshold and how far below or above that threshold is, then the computer system instructs some action to be taken, including an alarm, a diversion of the UMV to an emergency position, or a small diversion, or some recording of some fault, forwarding notification of a breach to an authority via a network to a device.

It into be noted that, throughout the description and claims of this specification, the word ‘comprise’ and variations of the word, such as ‘comprising’ and ‘comprises’, is not intended to exclude other variants or additional components, integers or steps. Modifications and improvements to the invention will be readily apparent to those skilled in the art. Such modifications and improvements are intended to be within the scope of this invention.

1. A computer implemented method of real-time condition monitoring of one or more UMVs, the method including the steps of:
receiving, in a control centre computer processing system, sensed unmanned vehicle (UMV) condition data from one or more condition sensors onboard a UMV;
receiving, in the control centre computer processing system, sensed UMV condition data from one or more condition sensors disposed on a network of condition-sensing stations;
comparing, in the control centre computer processing system, the sensed condition data from the condition sensors onboard the UMV with the condition sensors disposed on the condition-sensing stations; and
instructing, by the control centre computer processing system, the UMV to take an action in response to the comparison of sensed condition data.

2. The method of claim 1 wherein the method includes the step of recording a discrepancy, above a selected threshold, between the compared sensed condition data obtained from the UMV and the condition-sensing stations, as a fault.

3. The method of claim 1 wherein the method includes the step of transmitting the fault to a compliance engine.

4. The method of claim 1 further including the step of assessing, in the compliance engine, a severity of the fault against another threshold and transmits an alarm signal if the severity exceeds the other selected threshold.

5. The method of claim 4 wherein the alarm is forwarded to an owner or pilot/operator of the UMV.

6. The method of claim 5 wherein the alarm is forwarded to law or other enforcement agencies, together with the condition data relating to the UMV.

7. The method of claim 1 further including the step of transferring, or receiving, into the control centre computer processing system, a mission plan, or an emergency route plan for the UMV.

8. The method of claim 7 further including the steps of, by the condition sensing UMV tracking stations, interrogating a UMV to receive the mission plan therein.

9. The method of claim 7 wherein the method includes the steps of receiving the UMV mission plan, or emergency route plan, from the UMV or the condition sensing UMV tracking stations, and storing the mission plan, or emergency route plan, in a storage device in the control centre computer processing system.63

10. The method of claim 1 wherein the method includes the step of, by the control centre computer processing system, controlling the UMV to a safe area in the received emergency plan or back to the mission path in the received mission plan.

11. The method of claim 10 wherein the UMV is controlled in response to a fault or a plurality of faults.

12. The method of claim 10 wherein the control path is recorded onboard the UMV or the condition sensing stations.

13. The method of claim 1 further including the steps of:
receiving and recording in the control centre computer processing system, the condition of the UMV in range of each condition sensing station;
constructing in the control centre computer processing system, an executed mission route;
comparing in the control centre computer processing system, the executed mission route with the mission plan; and
recording discrepancies in a substantially permanent memory on board the UMV or in the control centre computer processing system.

14. The method of claim 1 wherein the sensing systems are selected from the group consisting of: rangefinders, laser positioning, radar positioning, optical positioning, infra-red positioning, infra-red position sensing, GSM and GPS low-orbit satellite position sensing; and
comparing the position data between the sensors.

15. The method of claim 1 further including the step of comparing the position of two or more proximal UMVs relative to a threshold distance between them, and
sending an alarm signal to an owner device in the event that the threshold is breached.

16. The method of claim 13 further including the step of disabling the UMV if the number or severity of discrepancies in the compared data are above a selected threshold.

17. The method of claim 16 wherein the disabling step is undertaken during or after a mission, depending on the severity of the discrepancy.

18. The method of claim 1 further including receiving in the control centre computer processing system, position data from sensors including cameras, lasers, infra-red, thermocouple, tachometer, radar, or rangefinders, mounted on the position sensors or on the UMV,
processing, with the control centre computer processing system, the data to predict a failure of componentry or mission route and
instruct an action be taken in response.

19. The method of claim 1 including, in the control system computer processing system, monitoring data transfer speed and volume between the UMV and the condition sensing stations; and
assessing if the data transfer speed is below a selected threshold;
filtering or compressing or reducing the data from selected sensors to facilitate comparison of condition data between UMV and condition sensing stations.

20. The method of claim 1 wherein the control processing system disables the UMV unless an emergency mission route is stored on board for deployment in the event of a break in communication between the condition sensing stations and the UMV.
